(19) United States
(12) Patent Application Publication
(10) Pub. No.: US 2026/0125619 A1
(43) Pub. Date: May 7, 2026

(54) STABILIZING SYSTEM FOR LAUNDRY EMULSIONS

(71) Applicant: ECOLAB USA INC., Saint Paul, MN (US)

(72) Inventors: BJOERN PAUTSCH, Monheim am Rhein (DE); Thomas Duerrschmidt, Monheim am Rhein (DE); MICHAEL LEDE, Monheim am Rhein (DE); RENATE SCHEGETZ, Monheim am Rhein (DE)

(21) Appl. No.: 19/438,170

(22) Filed: Dec. 31, 2025

Related U.S. Application Data
(63) Continuation of application No. 16/801,344, filed on Feb. 26, 2020, now abandoned.
(60) Provisional application No. 62/811,934, filed on Feb. 28, 2019.
(60) Provisional application No. 62/873,262, filed on Jul. 12, 2019.

(51) Int. Cl. C11D 3/12; C11D 1/72; C11D 3/18; C11D 3/28; C11D 3/33; C11D 3/34; C11D 3/36; C11D 3/37

(52) U.S. Cl. CPC C11D 3/1213; C11D 1/72; C11D 3/187; C11D 3/28; C11D 3/33; C11D 3/349; C11D 3/364; C11D 3/3723; C11D 3/3765; C11D 2111/12

(57) ABSTRACT

Improved liquid detergent concentrate compositions which are phosphorus free and utilize an acrylic copolymer to provide improved stability while maintaining viscosity are provided. Methods of using the same to wash textiles are also provided. The improved liquid detergent composition may be provided in the form of the concentrated emulsion or a use solution; and where the concentrated emulsion can be a water-in-oil emulsion or oil-in-water emulsion dependent on the amounts of water and oil in the emulsion.

### CROSS REFERENCE TO RELATED APPLICATIONS

This application is a continuation of, and claims priority to, patent application U.S. Ser. No. 16/801,344, filed Feb. 26, 2020 (the specification and claims of which are hereby incorporated by reference in their entirety), which claims priority under 35 U.S.C. § 119(e) to provisional patent application U.S. Ser. No. 62/811,934, filed Feb. 28, 2019 entitled “STABILIZING SYSTEM FOR LAUNDRY EMULSIONS,” and U.S. Ser. No. 62/873,262 filed Jul. 12, 2019, entitled “STABILIZING SYSTEM FOR LAUNDRY EMULSIONS,” each of which this application claims priority to and which are hereby incorporated by reference in their entirety.

### TECHNICAL FIELD

The application relates to an improved liquid detergent concentrate composition, which demonstrates improved stability while maintaining a preferred viscosity, and to a method for washing textiles. The liquid detergent composition can be provided as a concentrate or as a use solution. The liquid detergent composition in the form of the concentrate or the use solution is an emulsion of the type water-in-oil emulsion or oil-in-water emulsion dependent on the amounts of water and oil in the emulsion.

### BACKGROUND

Liquid detergents are known from the state of the art. Such detergents are, for example, described in U.S. Pat. No. 5,880,083, WO 2004/065535 A1, and WO 2004/041990 A1. One problem in the formulation of liquid detergent is to develop formulations that can be judged satisfactory regarding the performance perspective, namely that soil is sufficiently removed, the fabric is pleasantly soft and free of yellowing/fading, and the fabric is not damaged in the cleaning process. On the other hand the emulsions need to be sufficiently viscous and stable storage, so that even under temperature stress over several months, neither the viscosity collapses nor phase separation occurs. Some existing products separate during storage and are not readily redispersed. In some cases the product viscosity changes and it becomes either too thick to pour or so thin as to appear watery. Some clear products become cloudy and others gel on standing.

It is particularly challenging to stabilize highly alkaline emulsions while maintaining an ideal viscosity. A further challenge is added in creating a stabilized, highly alkaline emulsion which is cost-effective and easy to manufacture.

The document WO 2014/154244 discusses a liquid detergent composition comprising a stable emulsion. WO 2014/154244 utilizes a stabilizing system comprising a blend of two polymers, particularly an acrylic acid crosslinked copolymer (e.g. Carbopol®). However, the preparation and production of such a stabilizing system is less cost-effective.

Further, document WO 2007/101470 describes a liquid detergent composition which is storage-stable and shows a good washing performance. As nonionic surfactants, linear alkoxylated alcohols are used in the detergent composition. These are, for example, linear fatty alcohol ethoxylates having a C13-C15 alkyl group and 7 EO units. These liquid detergent concentrate compositions according to the state of art comprised about 1 wt. % to about 70 wt. % of said alkoxylated fatty alcohol. These liquid detergent compositions contain solubilizers which are able to keep the components in solution and the resulting emulsion stable even over a longer storage time. This was achieved by the use of one or more cross-linked or partly cross-linked polyacrylic acids and/or polymethacrylic acids in the composition. These substances are used as thickener and stabilizer for a liquid detergent concentrate composition which represent an emulsion. These polyacrylic acid or polymethacrylic acid may be cross-linked or partly cross-linked with a polyalkenyl polyether compound as crosslinker. Those compounds are available under the trade name Carbopol® from Noveon.

A drawback of such existing compositions is the production process to introduce the cross-linked or partly cross-linked polyacrylic acid/polymethacrylic acid thickener and stabilizers into the emulsion. The production process of the emulsions of the state of art requires the use of a pre-mix to introduce the thickening polymer, i.e. the solid cross-linked or partly cross-linked polyacrylic acid/polymethacrylic acid, into the formula. This pre-mix is both expensive and time-consuming due to the nature of the addition, which also involves a milling step. Within the pre-mix, a powder eductor recirculates a liquid surfactant to which the powder polymer is added. This pre-mix is then added to the rest of the emulsion.

Surprisingly, the present application has found that an acrylic copolymer can reduce the cost of production and provide improved stabilization while maintaining viscosity. Beneficially, the cost-effective compositions of the application may be produced by using a pre-mix, or without requiring a pre-mix.

Accordingly, an object of the application is to provide a liquid detergent composition having improved stability, in particular having an emulsion which is stable for at least a year, and which provides improved or at last substantially similar cleaning performance as other existing liquid detergent compositions.

A further object of the application is to provide a liquid detergent composition which maintains an ideal viscosity.

A further object of the application is to provide a more cost-effective, stable, and viscous liquid detergent composition which may be prepared using a pre-mix or without requiring a pre-mix.

Other objects, advantages and features of the detergent compositions disclosed herein and use thereof will become apparent from the following specification taken in conjunction with the accompanying drawings.

### BRIEF SUMMARY

An advantage of the application is that the liquid detergent compositions can provide improved stability during storage, while maintaining a preferred viscosity, i.e. the viscosity does not collapse, become too viscous, etc. Another advantage of the application is that the compositions are cost-effective, and may be produced by using a pre-mix, or without requiring a pre-mix.

In an embodiment, the compositions of the application comprise stable liquid detergent compositions comprising an alkalinity source, wherein the alkalinity source is in a concentration of between about 1 wt. % and about 90 wt. %, a chelating/sequestering agent, wherein the chelating/sequestering agent is selected from the group consisting of a polymeric chelating/sequestering agent, an aminocarboxylic acid or salt thereof, gluconic acid or a salt thereof, or a mixture thereof, an acrylic copolymer thickening agent; at least one nonionic surfactant; and at least one whitening agent; wherein the pH of the composition is between about 9 and about 14; and wherein the composition comprises a stable emulsion having a water phase and an oil phase.

In a more preferred embodiment, the chelating/sequestering agent comprises a polymeric chelating agent, an aminocarboxylic acid or salt thereof, and gluconic acid or salt thereof. Still more preferably, polymeric chelating agent comprises a polycarboxylic acid or salt thereof.

In a preferred embodiment, the optical brightener comprises one or more stilbene derivatives. In a most preferred embodiment, the optical brighter comprises a 4,4′-distyryl biphenyl derivative, a derivative of bis(triazinyl)amino-stilbene, a bisacylamino derivative of stilbene, a triazole derivative of stilbene, a triazine derivative of stilbene, an oxadiazole derivative of stilbene, an oxazole derivative of stilbene, a styryl derivative of stilbene, or a mixture thereof.

In some aspects, the liquid detergent composition is provided as a concentrate. In an embodiment, the composition exhibits less than 10% phase separation for at least one year.

A preferred embodiment is also found in a method of washing textiles comprising providing the liquid detergent composition and washing the textiles in an institutional or a household washing machine; wherein the liquid detergent composition comprising an alkalinity source, wherein the alkalinity source is in a concentration of between about 1 wt. % and about 90 wt. %, a chelating/sequestering agent, wherein the chelating/sequestering agent is selected from the group consisting of a polymeric chelating/sequestering agent, an aminocarboxylic acid or salt thereof, gluconic acid or a salt thereof, or a mixture thereof, an acrylic copolymer thickening agent; at least one nonionic surfactant; and at least one whitening agent; wherein the pH of the composition is between about 9 and about 14; and wherein the composition comprises a stable emulsion having a water phase and an oil phase.

While multiple embodiments are disclosed, still other embodiments of the present application will become apparent to those skilled in the art from the following detailed description, which shows and describes illustrative embodiments of the application. Accordingly, the drawings and detailed description are to be regarded as illustrative in nature and not restrictive.

### DETAILED DESCRIPTION

The embodiments of this application are not limited to a particular method and/or product, which can vary and are understood by skilled artisans. It is further to be understood that all terminology used herein is for the purpose of describing particular embodiments only, and is not intended to be limiting in any manner or scope. For example, as used in this specification and the appended claims, the singular forms “a,” “an” and “the” can include plural referents unless the content clearly indicates otherwise. Further, all units, prefixes, and symbols may be denoted in its SI accepted form.

Numeric ranges recited within the specification are inclusive of the numbers defining the range and include each integer within the defined range. Throughout this disclosure, various aspects of this application are presented in a range format. It should be understood that the description in range format is merely for convenience and brevity and should not be construed as an inflexible limitation on the scope of the application. Accordingly, the description of a range should be considered to have specifically disclosed all the possible sub-ranges as well as individual numerical values within that range. For example, description of a range such as from 1 to 6 should be considered to have specifically disclosed sub-ranges such as from 1 to 3, from 1 to 4, from 1 to 5, from 2 to 4, from 2 to 6, from 3 to 6 etc., as well as individual numbers within that range, for example, 1, 2, 3, 4, 5, and 6. This applies regardless of the breadth of the range.

So that the present application may be more readily understood, certain terms are first defined. Unless defined otherwise, all technical and scientific terms used herein have the same meaning as commonly understood by one of ordinary skill in the art to which embodiments of the application pertain. Many methods and materials similar, modified, or equivalent to those described herein can be used in the practice of the embodiments of the present application without undue experimentation, the preferred materials and methods are described herein. In describing and claiming the embodiments of the present application, the following terminology will be used in accordance with the definitions set out below.

The term “about,” as used herein, refers to variation in the numerical quantity that can occur, for example, through typical measuring and liquid handling procedures used for making concentrates or use solutions in the real world; through inadvertent error in these procedures; through differences in the manufacture, source, or purity of the ingredients used to make the compositions or carry out the methods; and the like. The term “about” also encompasses amounts that differ due to different equilibrium conditions for a composition resulting from a particular initial mixture. Whether or not modified by the term “about,” the claims include equivalents to the quantities.

The term “actives” or “percent actives” or “percent by weight actives” or “actives concentration” are used interchangeably herein and refers to the concentration of those ingredients involved in cleaning expressed as a percentage minus inert ingredients such as water or salts.

As used herein, the term “alkyl” or “alkyl groups” refers to saturated hydrocarbons having one or more carbon atoms, including straight-chain alkyl groups (e.g., methyl, ethyl, propyl, butyl, pentyl, hexyl, heptyl, octyl, nonyl, decyl, etc.), cyclic alkyl groups (or “cycloalkyl” or “alicyclic” or “carbocyclic” groups) (e.g., cyclopropyl, cyclopentyl, cyclohexyl, cycloheptyl, cyclooctyl, etc.), branched-chain alkyl groups (e.g., isopropyl, tert-butyl, sec-butyl, isobutyl, etc.), and alkyl-substituted alkyl groups (e.g., alkyl-substituted cycloalkyl groups and cycloalkyl-substituted alkyl groups).

Unless otherwise specified, the term “alkyl” includes both “unsubstituted alkyls” and “substituted alkyls.” As used herein, the term “substituted alkyls” refers to alkyl groups having substituents replacing one or more hydrogens on one or more carbons of the hydrocarbon backbone. Such substituents may include, for example, alkenyl, alkynyl, halogeno, hydroxyl, alkylcarbonyloxy, arylcarbonyloxy, alkoxycarbonyloxy, aryloxy, aryloxycarbonyloxy, carboxylate, alkylcarbonyl, arylcarbonyl, alkoxycarbonyl, aminocarbonyl, alkylaminocarbonyl, dialkylaminocarbonyl, alkylthiocarbonyl, alkoxyl, phosphate, phosphonato, phosphinato, cyano, amino (including alkyl amino, dialkylamino, arylamino, diarylamino, and alkylarylamino), acylamino (including alkylcarbonylamino, arylcarbonylamino, carbamoyl and ureido), imino, sulfhydryl, alkylthio, arylthio, thiocarboxylate, sulfates, alkylsulfinyl, sulfonates, sulfamoyl, sulfonamido, nitro, trifluoromethyl, cyano, azido, heterocyclic, alkylaryl, or aromatic (including heteroaromatic) groups.

As used herein, the term “cleaning” refers to a method used to facilitate or aid in soil removal, bleaching, microbial population reduction, and any combination thereof. As used herein, the term “microorganism” refers to any noncellular or unicellular (including colonial) organism. Microorganisms include all prokaryotes. Microorganisms include bacteria (including cyanobacteria), spores, lichens, fungi, protozoa, virinos, viroids, viruses, phages, and some algae. As used herein, the term “microbe” is synonymous with microorganism.

For the purpose of this patent application, successful microbial reduction is achieved when the microbial populations are reduced by at least about 50%, or by significantly more than is achieved by a wash with water. Larger reductions in microbial population provide greater levels of protection.

The term “laundry” refers to items or articles that are cleaned in a laundry washing machine. In general, laundry refers to any item or article made from or including textile materials, woven fabrics, non-woven fabrics, and knitted fabrics. The textile materials can include natural or synthetic fibers such as silk fibers, linen fibers, cotton fibers, polyester fibers, polyamide fibers such as nylon, acrylic fibers, acetate fibers, and blends thereof including cotton and polyester blends. The fibers can be treated or untreated. Exemplary treated fibers include those treated for flame retardancy. It should be understood that the term “linen” is often used to describe certain types of laundry items including bed sheets, pillow cases, towels, table linen, table cloth, bar mops and uniforms. The application additionally provides a composition and method for treating non-laundry articles and surfaces including hard surfaces such as dishes, glasses, and other ware.

As used herein, the term “polymer” generally includes, but is not limited to, homopolymers, copolymers, such as for example, block, graft, random and alternating copolymers, terpolymers, and higher “x”mers, further including their derivatives, combinations, and blends thereof. Furthermore, unless otherwise specifically limited, the term “polymer” shall include all possible isomeric configurations of the molecule, including, but are not limited to isotactic, syndiotactic and random symmetries, and combinations thereof.

Furthermore, unless otherwise specifically limited, the term “polymer” shall include all possible geometrical configurations of the molecule.

As used herein, the term “substantially free” refers to compositions completely lacking the component or having such a small amount of the component that the component does not affect the performance of the composition. The component may be present as an impurity or as a contaminant and shall be less than 0.5 wt. %. In another embodiment, the amount of the component is less than 0.1 wt. % and in yet another embodiment, the amount of component is less than 0.01 wt. %.

The term “substantially similar” or a variation thereof refers generally to a substitute ingredient (e.g., liquid acid substituted with solidified acid) to providing generally the same degree (or at least not a significantly lesser degree) of the referenced activity or effect.

The term “surfactant” as used herein is a compound that contains a lipophilic segment and a hydrophilic segment, which when added to water or solvents, reduces the surface tension of the system.

As used herein, the term “ware” refers to items such as eating and cooking utensils, dishes, and other hard surfaces such as showers, sinks, toilets, bathtubs, countertops, windows, mirrors, transportation vehicles, and floors. As used herein, the term “warewashing” refers to washing, cleaning, or rinsing ware. Ware also refers to items made of plastic. Types of plastics that can be cleaned with the compositions according to the application include but are not limited to, those that include polycarbonate polymers (PC), acrilonitrile-butadiene-styrene polymers (ABS), and polysulfone polymers (PS). Another exemplary plastic that can be cleaned using the compounds and compositions of the application include polyethylene terephthalate (PET).

The term “weight percent,” “wt. %,” “percent by weight,” “% by weight,” and variations thereof, as used herein, refer to the concentration of a substance as the weight of that substance divided by the total weight of the composition and multiplied by 100. It is understood that, as used here, “percent,” “%,” and the like are intended to be synonymous with “weight percent,” “wt. %,” etc.

The methods and compositions of the present application may comprise, consist essentially of, or consist of the components and ingredients of the present application as well as other ingredients described herein. As used herein, “consisting essentially of” means that the methods and compositions may include additional steps, components or ingredients, but only if the additional steps, components or ingredients do not materially alter the basic and novel characteristics of the claimed methods and compositions.

### Compositions

According to embodiments, the compositions include an acrylic copolymer together with at least one nonionic surfactant, at least one whitening agent, a chelating/sequestering agent, a polycarboxylic acid, and a source of alkalinity. The compositions may be provided as a liquid detergent concentrate comprising an emulsion having a water phase and an oil phase.

Exemplary detergent compositions are shown in Table 1 in weight percentage.

TABLE 1

| | First | Second | Third |
|---|---|---|---|
| | Exemplary | Exemplary | Exemplary |
| Material | Range wt.-% | Range wt.-% | Range wt.-% |
| Alkalinity source | 1-90 | 10-50 | 10-40 |
| First Whitening Agent | 0.001-5 | 0.01-3 | 0.1-1 |
| Second Whitening Agent | 0.001-5 | 0.01-3 | 0.1-2 |
| Phosphonate | 0-20 | 1-15 | 1-10 |
| Chelating/Sequestering | 1-20 | 1-15 | 1-10 |
| Agent | | | |
| Polycarboxylic Acid | 0.1-10 | 0.5-7 | 1-5 |
| Nonionic Surfactant | 1-70 | 5-50 | 5-30 |
| Acrylic Copolymer | 0.1-10 | 1-5 | 2-4 |
| Additional Functional | 0-20 | 1-15 | 5-10 |
| Ingredients | | | |
| Water | 0-99 | 5-75 | 10-50 |

The liquid detergent concentrate composition according to the application is a stable emulsion which exhibits less than 10% phase separation when being stored. The emulsion is also stable at lower temperatures, for example −5° C. If the emulsion is frozen at temperatures below −10° C. and melted thereafter, the emulsion is formed again without stirring the composition. This is particularly important when the emulsion is stored outside for example in wintertime where outside temperatures are lower than −5° C. Even under these extreme conditions the liquid detergent concentrate composition according to the application is a stable emulsion, does not separate and recovers completely at ambient temperatures.

Usually the detergent composition is made available as a concentrate and/or shipped or stored as a concentrate in order to avoid the expense associated with shipping and/or storing a composition containing a large amount of water. The concentrate is then normally diluted at the location of use to provide a use solution. Furthermore, it is also possible that the concentrate is first diluted to provide a more dilute concentrate and then a ready-to-use composition is prepared by further diluting the diluted concentrate.

Beneficially, the detergent compositions are stable, flowable emulsions which do not undergo phase separation during storage or when exposed to highly different temperature ranges. In an aspect, the detergent compositions do not undergo phase separation at room temperature storage for a period of at least 6 months. In an aspect, the detergent compositions do not undergo phase separation at 40° C.-50° C. and/or refrigeration between 2° C.-10° C. storage for a period of at least 8 weeks (which is also illustrative of room temperature stability of 6 months). As referred to herein, a lack of phase separation is confirmed by less than 10%, preferably less than 5% separation of the detergent composition over the period of time and under defined temperature conditions.

### Viscosity

In a preferred embodiment, the liquid detergent concentrate compositions have a viscosity range of from about 1 mPas to about 3000 mPas, 1 mPas to 1500 mPas, 1 mPas to 1000 mPas, at 20° C. measured at 20 revolutions per minute on a Brookfield RVT viscosimeter with spindle #2. The liquid detergent concentrate compositions according to the application preferably has a viscosity in the range of from 300 mPas to 3000 mPas, 300 mPas to 1500 mPas, 300 mPas to 1000 mPas, further preferred 300 mPas to 900 mPas, still further preferred 350 mPas to 900 mPas, and most preferred from 400 mPas to 700 mPas at 20° C. measured at 20 revolutions per minute on a Brookfield RVT viscosimeter with spindle no. 2. This low viscosity allows to pump the liquid detergent concentrate by using standard pumping devices and it is not necessary to use specific pumping devices for high-viscous liquids. Because of the low viscosity of the product, it can be dosed by usual standard peristaltic pumps which are much cheaper than pumps for higher viscous fluids.

### Source of Alkalinity

The liquid detergent composition comprises one or more alkalinity sources in an amount of about 1 wt. % to about 90 wt. %, preferably from about 10 to about 30 wt. %. The source of alkalinity can be any source of alkalinity that is compatible with the other components of the detergent composition. Exemplary sources of alkalinity include alkali metal hydroxides, alkali metal carbonates, alkali metal silicates, alkali metal salts, phosphates, amines, and mixtures thereof, preferably alkali metal hydroxides including sodium hydroxide, potassium hydroxide, and lithium hydroxide or mixtures thereof, and most preferred is sodium hydroxide and/or potassium hydroxide.

The liquid detergent concentrate composition according to the application may be provided as a highly alkaline concentrate or as a use solution based on the quantity of the alkalinity source. The alkalinity source controls the pH of the resulting solution when water is added to the detergent composition to form a use solution. The pH of the use solution must be maintained in the alkaline range in order to provide sufficient detergency properties. Further, the pH of the use solution is also useful for an optimized reduction in the germs count, such as bacteria, fungi, virus and spores, of the laundry washed with the detergent composition of the application, preferably in combination with the second component of the application. After the addition of the second component, the bleach base or peracid compound, the pH of the composition may be reduced. In a preferred embodiment, the pH of the use solution is at least 8, and is between approximately 9 and approximately 14. Particularly, the pH of the use solution is between about 10 and about 14. More particularly, the pH of the use solution is between about 11 and about 14. In a particularly preferred embodiment, the pH of the use solution is from about 12 to about 13.5 and the pH of the concentrate is from about 13 to 14.

Exemplary alkali metal hydroxides include sodium hydroxide, potassium hydroxide, and lithium hydroxide. However, most preferred is sodium hydroxide. The source of alkalinity, preferably an alkali metal hydroxide, can be included in a variety of forms, including for example in the form of solid beads, dissolved in an aqueous solution or a combination thereof. Alkali metal hydroxides are commercially available as pellets or beads having a mix of particle sizes, or as an aqueous solution having an active concentration between about 20% and about 90% in the solution, preferred active concentrations in a solution, include, but are not limited to, about 45%, about 50%, and about 73% alkalinity in the alkaline solution.

Exemplary alkali metal salts include without limitation sodium carbonate, trisodium phosphate, potassium carbonate, and mixtures thereof. Exemplary phosphates include without limitation sodium pyrophosphate, potassium pyrophosphate, and mixtures thereof. Exemplary amines include without limitation alkanolamine selected from the group comprising triethanolamine, monoethanolamine, diethanolamine, and mixtures thereof.

In some embodiments, the alkalinity source is included in the detergent composition at an amount of at least about 1 wt. % to about 90 wt. %, about 1 wt. % to about 80 wt. %, about 1 wt. % to about 70 wt. %, about 1 wt. % to about 60 wt. %, about 1 wt. % to about 50 wt. %, about 10 wt. % to about 50 wt. %,about 10 wt. % to about 40 wt. %,or about 20 wt. % to about 40 wt. %. In certain cleaning contexts, it is preferable to reduce the amount of alkalinity employed in a detergent composition. However, this must be balanced by the need to keep the pH of detergent compositions sufficiently high provide the desired detergency and cleaning. With that in mind, it has been found that the compositions can still be made sufficiently alkaline (e.g., a pH of between about 9 and 14, more preferably between about 10 and 14, most preferably between about 12 and 14) with the use of lesser amounts of alkalinity. In such an embodiment, the composition has between about 1 wt. % and about 40 wt. %, more preferably between about 5 wt. % and about 30 wt. %, most preferably between about 10 wt. % and about 25 wt. %. It should be understood that the amounts recited are in weight percentage and not based on active concentration of hydroxide. For example, 10-25 wt. % of a 50% active alkalinity source will have 5-12.5% active concentration of alkalinity.

Further, we have found that in some embodiments a certain level of alkalinity source benefits the stability of the compositions. In such an embodiment, it is preferred that there be at least about 5% active concentration of alkalinity source, more preferably at least about 8% active concentration of alkalinity source, most preferably at least about 10% active concentration of alkalinity source.

### Nonionic Surfactants

The liquid detergent concentrate composition preferably comprises at least one nonionic surfactant, present from about 1 to about 70 wt. % of a nonionic surfactant. In preferred embodiments the compositions of the present application include about 5 to about 30 wt. %, further preferred about 5 to 20 wt. % and particularly preferred about 5 to about 18 wt. % of a nonionic surfactant.

Nonionic surfactants suitable for use with the compositions of the present application include synthetic or natural alcohols that are alkoxylated (with ethylene and/or propylene and/or butylene oxide) to yield a variety of C₆-C₂₄ alcohol ethoxylates and/or propoxylates and/or butoxylates (preferably C₅-C₁₄ alcohol ethoxylates and/or propoxylates and/or butoxylates having 1 to 20 alkylene oxide groups (preferably 2 to 20 alkylene oxide groups); C₅-C₂₄ alkylphenol ethoxylates (preferably C₈-C₁₀ alkylphenol ethoxylates) having 1 to 100 ethylene oxide groups (preferably about 12 to about 20 ethylene oxide groups); and C5-C24 alkylpolyglycosides (preferably C₅-C₂₀ alkylpolyglycosides) having 1 to 20 glycoside groups (preferably 9 to 20 glycoside groups).

Suitable alkoxylated surfactants for use as surfactants include EO/PO block copolymers, such as the Pluronic® and reverse Pluronic® surfactants; alcohol alkoxylates, such as Dehypon® LS-54 (R-(EO)₅(PO)₄); wherein R represents a linear or branched fatty alcohol residue) and Dehypon® LS-36 (R-(EO)₃(PO)₆; wherein R represents a linear or branched fatty alcohol residue); and capped alcohol alkoxylates, such as Plurafac® LF221 and Tegoten® EC11; mixtures thereof, or the like. More specifically the composition of the present application can include alkoxylated primary or secondary alcohol having from 6 to 24, preferably 6 to 22, more preferred 8 to 18 carbon atoms reacted with from 2 to 18 moles of ethylene, and/or propylene, and/or butylene oxide. In a preferred embodiment the nonionic has from 3 to 18 moles of alkylene oxide, in another preferred embodiment from 3 to 10 moles of ethylene oxide, and in yet another preferred embodiment 7 to 8 moles of EO. These materials are commercially available and well-known nonionic surfactants. The following materials are useful: lauryl alcohol ethoxylated with 3 moles of ethylene oxide (EO), coco alcohol ethoxylated with 3 moles EO, stearyl alcohol ethoxylated with 5 moles EO, mixed C₁₂-C₁₅ alcohol ethoxylated with 7 moles EO, mixed secondary C₁₁-C₁₅ alcohol ethoxylated with 7 moles EO, mixed C₉-C₁₁ linear alcohol ethoxylated with 6 moles EO and the like.

In preferred embodiment the nonionic has from 8 to 15 carbon atoms in the alkyl group. When this alkyl group is used a nonionic is the mixed C₁₂-C₁₅ alcohol ethoxylated with 7 moles EO. In a further preferred embodiment it comprises the alcohol alkoxylates, particularly the alcohol ethoxylates and propoxylates, especially the mixed ethoxylates and propoxylates, particularly with 3-7 oxyethylene (EO) units and 3-7 oxypropylene (PO) units such as the alcohol Dehypon® available from BASF Corporation, having 5 EO units and 4 PO units. In another preferred embodiment it comprises the alcohol alkoxylates, particularly C₁₂-C₁₅ alcohol (e.g. mixed C₁₃/C₁₅ alcohol, iso-tridecanol), particularly with 2-20 oxyethylene (EO) units, preferably with 5-12 oxyethylene (EO) units, further preferred with 5-10 oxyethylene (EO) units, in particular with 7 or 8 oxyethylene (EO) units, such as the Lutensol® TO, particularly TO 8, available from BASF and Lutensol® AO, such as AO7 and AO3, available from BASF.

Suitable alkoxylated surfactants for use as surfactants further include a guerbet alcohol ethoxylate of the formula R⁶ —(OC₂H₄)ₘ—OH, wherein R⁶ is a branched C₉ to C₂₀ alkyl group, preferably a branched C₉ to C₁₈ alkyl group, further preferred a branched C₉-C₁₅ alkyl group, more preferred a branched C₉-C₁₁ alkyl group, most preferred a branched C₁₀ alkyl group and m is from 2 to 10, preferably 2 to 6. Such guerbet alcohols are available, for example, under the trade name Lutensol® XP or M from BASF or Eutanol® G from BASF.

The guerbet reaction is a self-condensation of alcohols by which alcohols having branched alkyl chains are produced. The reaction sequence is related to the Aldol condensation and occurs at high temperatures under catalytic conditions. The product is a branched alcohol with twice the molecular weight of the reactant minus a mole of water. The reaction proceeds by a number of sequential reaction steps. At first the alcohol is oxidized to an aldehyde. Then Aldol condensation takes place after proton extraction. Thereafter the aldol product is dehydrated and the hydrogenation of the allylic aldehyde takes place.

These products are called guerbet alcohols and are further reacted to the nonionic alkoxylated guerbet alcohols by alkoxylation with i.e. ethylene oxide or propylene oxide. The ethoxylated guerbet alcohols have a lower solubility in water compared to the linear ethoxylated alcohols with the same number of carbon atoms. Therefore the exchange of linear fatty alcohols by branched fatty alcohols makes it necessary to use good solubilizers which are able to keep the guerbet alcohol in solution and the resulting emulsion stable even over a longer storage time.

### Additional Surfactants

According to some embodiments, the composition may further comprise additional surfactants, including without limitation one or more anionic, zwitterionic, cationic, and/or amphoteric surfactants. Where utilized, the one or more additional surfactants may be present in the composition from about 0 wt. % to about 90 wt. %, inclusive of all integers between.

Anionic surface-active substances which are categorized as such because the charge on the hydrophobe is negative or surfactants in which the hydrophobic section of the molecule carries no charge unless the pH is elevated to neutrality or above (e.g. carboxylic acids) can also be employed in certain embodiments. Carboxylate, sulfonate, sulfate and phosphate are the polar (hydrophilic) solubilizing groups found in anionic surfactants. Of the cations (counter ions) associated with these polar groups, sodium, lithium and potassium impart water solubility; ammonium and substituted ammonium ions provide both water and oil solubility; and, calcium, barium, and magnesium promote oil solubility.

Anionic sulfate surfactants suitable for use in the present compositions include alkyl ether sulfates, alkyl sulfates, the linear and branched primary and secondary alkyl sulfates, alkyl ethoxysulfates, fatty oleyl glycerol sulfates, alkyl phenol ethylene oxide ether sulfates, the C₅-C₁₇ acyl-N—(C₁-C₄ alkyl) and —N—(C₁-C₂ hydroxyalkyl) glucamine sulfates, and sulfates of alkylpolysaccharides such as the sulfates of alkylpolyglucoside, and the like. Also included are the alkyl sulfates, alkyl poly(ethyleneoxy) ether sulfates and aromatic poly(ethyleneoxy) sulfates such as the sulfates or condensation products of ethylene oxide and nonyl phenol (usually having 1 to 6 oxyethylene groups per molecule).

Anionic sulfonate surfactants suitable for use in the present compositions also include alkyl sulfonates, the linear and branched primary and secondary alkyl sulfonates, and the aromatic sulfonates with or without substituents.

Anionic carboxylate surfactants suitable for use in the present compositions include carboxylic acids (and salts), such as alkanoic acids (and alkanoates), ester carboxylic acids (e.g. alkyl succinates), ether carboxylic acids, sulfonated fatty acids, such as sulfonated oleic acid, and the like. Such carboxylates include alkyl ethoxy carboxylates, alkyl aryl ethoxy carboxylates, alkyl polyethoxy polycarboxylate surfactants and soaps (e.g. alkyl carboxyls).

Secondary carboxylates useful in the present compositions include those which contain a carboxyl unit connected to a secondary carbon. The secondary carbon can be in a ring structure, e.g. as in p-octyl benzoic acid, or as in alkyl-substituted cyclohexyl carboxylates.

The secondary carboxylate surfactants typically contain no ether linkages, no ester linkages and no hydroxyl groups. Further, they typically lack nitrogen atoms in the head-group (amphiphilic portion). Suitable secondary soap surfactants typically contain 11-13 total carbon atoms, although more carbons atoms (e.g., up to 16) can be present. Suitable carboxylates also include acylamino acids (and salts), such as acylgluamates, acyl peptides, sarcosinates (e.g. N-acyl sarcosinates), taurates (e.g. N-acyl taurates and fatty acid amides of methyl tauride), and the like.

Suitable anionic surfactants include alkyl or alkylaryl ethoxy carboxylates of the following formula:

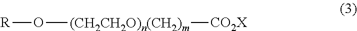

in which R is a C₈ to C₂₂ alkyl group or

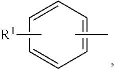

in which R¹ is a C₄-C₁₆ alkyl group; n is an integer of 1-20; m is an integer of 1-3; and X is a counter ion, such as hydrogen, sodium, potassium, lithium, ammonium, or an amine salt such as monoethanolamine, diethanolamine or triethanolamine. In some embodiments, n is an integer of 4 to 10 and m is 1. In some embodiments, R is a C₈-C₁₆ alkyl group. In some embodiments, R is a C₁₂-C₁₄ alkyl group, n is 4, and m is 1.

In other embodiments, R is

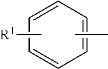

and R¹ is a C₆-C₁₂ alkyl group. In still yet other embodiments, R¹ is a C₉ alkyl group, n is 10 and m is 1.

Such alkyl and alkylaryl ethoxy carboxylates are commercially available. These ethoxy carboxylates are typically available as the acid forms, which can be readily converted to the anionic or salt form. Commercially available carboxylates include, Neodox 23-4, a C₁₂₋₁₃ alkyl polyethoxy (4) carboxylic acid (Shell Chemical), and Emcol CNP-110, a C₉ alkylaryl polyethoxy (10) carboxylic acid (Witco Chemical). Carboxylates are also available from Clariant, e.g. the product Sandopan® DTC, a C₁₃ alkyl polyethoxy (7) carboxylic acid.

Amphoteric, or ampholytic, surfactants contain both a basic and an acidic hydrophilic group and an organic hydrophobic group. These ionic entities may be any of anionic or cationic groups described herein for other types of surfactants. A basic nitrogen and an acidic carboxylate group are the typical functional groups employed as the basic and acidic hydrophilic groups. In a few surfactants, sulfonate, sulfate, phosphonate or phosphate provide the negative charge.

Amphoteric surfactants can be broadly described as derivatives of aliphatic secondary and tertiary amines, in which the aliphatic radical may be straight chain or branched and wherein one of the aliphatic substituents contains from about 8 to 18 carbon atoms and one contains an anionic water solubilizing group, e.g., carboxy, sulfo, sulfato, phosphato, or phosphono. Amphoteric surfactants are subdivided into two major classes known to those of skill in the art and described in “Surfactant Encyclopedia” Cosmetics & Toiletries, Vol. 104 (2) 69-71 (1989), which is herein incorporated by reference in its entirety. The first class includes acyl/dialkyl ethylenediamine derivatives (e.g. 2-alkyl hydroxyethyl imidazoline derivatives) and their salts. The second class includes N-alkylamino acids and their salts. Some amphoteric surfactants can be envisioned as fitting into both classes.

Amphoteric surfactants can be synthesized by methods known to those of skill in the art. For example, 2-alkyl hydroxyethyl imidazoline is synthesized by condensation and ring closure of a long chain carboxylic acid (or a derivative) with dialkyl ethylenediamine. Commercial amphoteric surfactants are derivatized by subsequent hydrolysis and ring-opening of the imidazoline ring by alkylation—for example with chloroacetic acid or ethyl acetate. During alkylation, one or two carboxy-alkyl groups react to form a tertiary amine and an ether linkage with differing alkylating agents yielding different tertiary amines.

Long chain imidazole derivatives having application in the present application generally have the general formula:

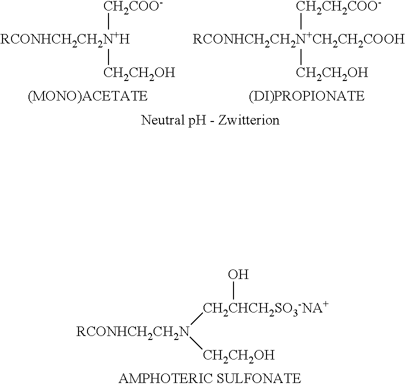

wherein R is an acyclic hydrophobic group containing from about 8 to 18 carbon atoms and M is a cation to neutralize the charge of the anion, generally sodium. Commercially prominent imidazoline-derived amphoterics that can be employed in the present compositions include for example: Cocoamphopropionate, Cocoamphocarboxy-propionate, Cocoamphoglycinate, Cocoamphocarboxy-glycinate, Cocoamphopropyl-sulfonate, and Cocoamphocarboxy-propionic acid. Amphocarboxylic acids can be produced from fatty imidazolines in which the dicarboxylic acid functionality of the amphodicarboxylic acid is diacetic acid and/or dipropionic acid.

The carboxymethylated compounds (glycinates) described herein above frequently are called betaines. Betaines are a special class of amphoteric discussed herein below in the section entitled, Zwitterion Surfactants.

Long chain N-alkylamino acids are readily prepared by reaction RNH₂, in which R=C₈-C₁₈ straight or branched chain alkyl, fatty amines with halogenated carboxylic acids.

Alkylation of the primary amino groups of an amino acid leads to secondary and tertiary amines. Alkyl substituents may have additional amino groups that provide more than one reactive nitrogen center. Most commercial N-alkylamine acids are alkyl derivatives of beta-alanine or beta-N(2-carboxyethyl) alanine. Examples of commercial N-alkylamino acid ampholytes having application in this application include alkyl beta-amino dipropionates, RN(C₂H₄COOM)₂ and RNHC₂H₄COOM. In an embodiment, R can be an acyclic hydrophobic group containing from about 8 to about 18 carbon atoms, and M is a cation to neutralize the charge of the anion.

Suitable amphoteric surfactants include those derived from coconut products such as coconut oil or coconut fatty acid. Additional suitable coconut derived surfactants include as part of their structure an ethylenediamine moiety, an alkanolamide moiety, an amino acid moiety, e.g., glycine, or a combination thereof; and an aliphatic substituent of from about 8 to 18 (e.g., 12) carbon atoms. Such a surfactant can also be considered an alkyl amphodicarboxylic acid. These amphoteric surfactants can include chemical structures represented as: C₁₂-alkyl-C(O)—NH—CH₂—CH₂—N+(CH₂—CH₂—CO₂Na)₂—CH₂—CH₂—OH or C₁₂-alkyl-C(O)—N(H)—CH₂—CH₂—N+(CH₂—CO₂Na)₂—CH₂—CH₂—OH. Disodium cocoampho dipropionate is one suitable amphoteric surfactant and is commercially available under the tradename Miranol™ FBS from Rhodia Inc., Cranbury, N.J. Another suitable coconut derived amphoteric surfactant with the chemical name disodium cocoampho diacetate is sold under the tradename Mirataine™ JCHA, also from Rhodia Inc., Cranbury, N.J.

A typical listing of amphoteric classes, and species of these surfactants, is given in U.S. Pat. No. 3,929,678 issued to Laughlin and Heuring on Dec. 30, 1975. Further examples are given in “Surface Active Agents and Detergents” (Vol. I and II by Schwartz, Perry and Berch).

Zwitterionic surfactants can be thought of as a subset of the amphoteric surfactants and can include an anionic charge. Zwitterionic surfactants can be broadly described as derivatives of secondary and tertiary amines, derivatives of heterocyclic secondary and tertiary amines, or derivatives of quaternary ammonium, quaternary phosphonium or tertiary sulfonium compounds. Typically, a zwitterionic surfactant includes a positive charged quaternary ammonium or, in some cases, a sulfonium or phosphonium ion; a negative charged carboxyl group; and an alkyl group. Zwitterionics generally contain cationic and anionic groups which ionize to a nearly equal degree in the isoelectric region of the molecule and which can develop strong “inner-salt” attraction between positive-negative charge centers. Examples of such zwitterionic synthetic surfactants include derivatives of aliphatic quaternary ammonium, phosphonium, and sulfonium compounds, in which the aliphatic radicals can be straight chain or branched, and wherein one of the aliphatic substituents contains from 8 to 18 carbon atoms and one contains an anionic water solubilizing group, e.g., carboxy, sulfonate, sulfate, phosphate, or phosphonate.

Betaine and sultaine surfactants are exemplary zwitterionic surfactants for use herein. A general formula for these compounds is:

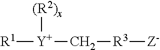

wherein R¹ contains an alkyl, alkenyl, or hydroxyalkyl radical of from 8 to 18 carbon atoms having from 0 to 10 ethylene oxide moieties and from 0 to 1 glyceryl moiety; Y is selected from the group consisting of nitrogen, phosphorus, and sulfur atoms; R² is an alkyl or monohydroxy alkyl group containing 1 to 3 carbon atoms; x is 1 when Y is a sulfur atom and 2 when Y is a nitrogen or phosphorus atom, R³ is an alkylene or hydroxy alkylene or hydroxy alkylene of from 1 to 4 carbon atoms and Z is a radical selected from the group consisting of carboxylate, sulfonate, sulfate, phosphonate, and phosphate groups.

Examples of zwitterionic surfactants having the structures listed above include: 4-[N,N-di(2-hydroxyethyl)-N-octadecylammonio]-butane-1-carboxylate; 5-[S-3-hydroxypropyl-S-hexadecylsulfonio]-3-hydroxypentane-1-sulfate; 3-[P,P-diethyl-P-3,6,9-trioxatetracosanephosphonio]-2-hydroxypropane-1-phosphate; 3-[N,N-dipropyl-N-3-dodecoxy-2-hydroxypropyl-ammonio]-propane-1-phosphonate; 3-(N,N-dimethyl-N-hexadecylammonio)-propane-1-sulfonate; 3-(N,N-dimethyl-N-hexadecylammonio)-2-hydroxy-propane-1-sulfonate; 4-[N,N-di(2(2-hydroxyethyl)-N(2-hydroxydodecyl)ammonio]-butane-1-carboxylate; 3-[S-ethyl-S-(3-dodecoxy-2-hydroxypropyl)sulfonio]-propane-1-phosphate; 3-[P,P-dimethyl-P-dodecylphosphonio]-propane-1-phosphonate; and S[N,N-di(3-hydroxypropyl)-N-hexadecylammonio]-2-hydroxy-pentane-1-sulfate. The alkyl groups contained in said detergent surfactants can be straight or branched and saturated or unsaturated.

The zwitterionic surfactant suitable for use in the present compositions includes a betaine of the general structure:

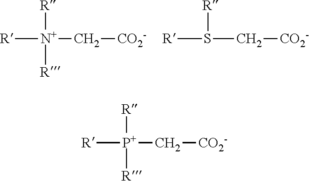

These surfactant betaines typically do not exhibit strong cationic or anionic characters at pH extremes nor do they show reduced water solubility in their isoelectric range. Unlike “external” quaternary ammonium salts, betaines are compatible with anionics. Examples of suitable betaines include coconut acylamidopropyldimethyl betaine; hexadecyl dimethyl betaine; C₁₂₋₁₄ acylamidopropylbetaine; C₈₋₁₄ acylamidohexyldiethyl betaine; 4-C₁₄₋₁₆ acylmethylamidodiethylammonio-1-carboxybutane; C₁₆₋₁₈ acylamidodimethylbetaine; C₁₂₋₁₆ acylamidopentanediethylbetaine; and C₁₂₋₁₆ acylmethylamidodimethylbetaine.

Sultaines useful in the present application include those compounds having the formula (R(R¹)₂ N⁺ R²SO³⁻, in which R is a C₆-C₁₈ hydrocarbyl group, each R¹ is typically independently C₁-C₃ alkyl, e.g. methyl, and R² is a C₁-C₆ hydrocarbyl group, e.g. a C₁-C₃ alkylene or hydroxyalkylene group.

A typical listing of zwitterionic classes, and species of these surfactants, is given in U.S. Pat. No. 3,929,678 issued to Laughlin and Heuring on Dec. 30, 1975. Further examples are given in “Surface Active Agents and Detergents” (Vol. I and II by Schwartz, Perry and Berch). Each of these references is herein incorporated in their entirety.

Cationic surfactants preferably include, more preferably refer to, compounds containing at least one long carbon chain hydrophobic group and at least one positively charged nitrogen. The long carbon chain group may be attached directly to the nitrogen atom by simple substitution; or more preferably indirectly by a bridging functional group or groups in so-called interrupted alkylamines and amido amines. Such functional groups can make the molecule more hydrophilic and/or more water dispersible, more easily water solubilized by co-surfactant mixtures, and/or water soluble. For increased water solubility, additional primary, secondary or tertiary amino groups can be introduced or the amino nitrogen can be quaternized with low molecular weight alkyl groups. Further, the nitrogen can be a part of branched or straight chain moiety of varying degrees of unsaturation or of a saturated or unsaturated heterocyclic ring. In addition, cationic surfactants may contain complex linkages having more than one cationic nitrogen atom.

The surfactant compounds classified as amine oxides, amphoterics and zwitterions are themselves typically cationic in near neutral to acidic pH solutions and can overlap surfactant classifications. Polyoxyethylated cationic surfactants generally behave like nonionic surfactants in alkaline solution and like cationic surfactants in acidic solution.

The simplest cationic amines, amine salts and quaternary ammonium compounds can be schematically drawn thus:

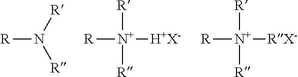

in which, R represents a long alkyl chain, R′, R″, and R′″ may be either long alkyl chains or smaller alkyl or aryl groups or hydrogen and X represents an anion. The amine salts and quaternary ammonium compounds are preferred for practical use in this application due to their high degree of water solubility.

The majority of large volume commercial cationic surfactants can be subdivided into four major classes and additional sub-groups known to those or skill in the art and described in “Surfactant Encyclopedia”, Cosmetics & Toiletries, Vol. 104 (2) 86-96 (1989). The first class includes alkylamines and their salts. The second class includes alkyl imidazolines. The third class includes ethoxylated amines. The fourth class includes quaternaries, such as alkylbenzyldimethylammonium salts, alkyl benzene salts, heterocyclic ammonium salts, tetra alkylammonium salts, and the like. Cationic surfactants are known to have a variety of properties that can be beneficial in the present compositions. These desirable properties can include detergency in compositions of or below neutral pH, antimicrobial efficacy, thickening or gelling in cooperation with other agents, and the like.

Cationic surfactants useful in the compositions of the present application include those having the formula R¹ₘR²ₓY_{L}Z wherein each R¹ is an organic group containing a straight or branched alkyl or alkenyl group optionally substituted with up to three phenyl or hydroxy groups and optionally interrupted by up to four of the following structures:

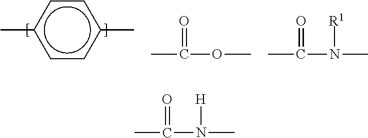

or an isomer or mixture of these structures, and which contains from about 8 to 22 carbon atoms. The R¹ groups can additionally contain up to 12 ethoxy groups. m is a number from 1 to 3. Preferably, no more than one R¹ group in a molecule has 16 or more carbon atoms when m is 2 or more than 12 carbon atoms when m is 3. Each R² is an alkyl or hydroxyalkyl group containing from 1 to 4 carbon atoms or a benzyl group with no more than one R² in a molecule being benzyl, and x is a number from 0 to 11, preferably from 0 to 6. The remainder of any carbon atom positions on the Y group are filled by hydrogens. Y is can be a group including, but not limited to:

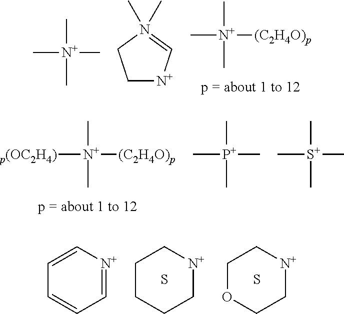

or a mixture thereof. Preferably, L is 1 or 2, with the Y groups being separated by a moiety selected from R¹ and R² analogs (preferably alkylene or alkenylene) having from 1 to about 22 carbon atoms and two free carbon single bonds when L is 2. Z is a water-soluble anion, such as a halide, sulfate, methylsulfate, hydroxide, or nitrate anion, particularly preferred being chloride, bromide, iodide, sulfate or methyl sulfate anions, in a number to give electrical neutrality of the cationic component.

### Chelants, Sequestrants, Builders, Water Conditioning Polymers

The compositions may also include one or more chelating/sequestering agent(s) or builders. In general, a sequestrant chelating agent or builder is a molecule capable of coordinating (i.e., binding) the metal ions commonly found in natural water to prevent the metal ions from interfering with the action of the other detersive ingredients of a detergent composition. For a further discussion of chelating agents/sequestrants, see Kirk Othmer, Encyclopedia of Chemical Technology, Third Edition, volume 5, pages 339-366 and volume 23, pages 319-320. In some embodiments, a phosphonate can be included and is preferred.

However, in other embodiments, it is preferred that the compositions be free of phosphonates, and other phosphorus containing compounds; in such an embodiment, the chelating/sequestering agent is preferably a non-phosphorus containing aminocarboxylate, gluconic acid salt, polymeric chelating agent, or combination thereof.

Suitable sequestrants include, but are not limited to, organic chelating compounds that sequester metal ions in solution, particularly transition metal ions. Such sequestrants include organic amino- or hydroxy-polyphosphonic acid complexing agents (either in acid or soluble salt forms), carboxylic acids (e.g., polymeric polycarboxylate), hydroxycarboxylic acids, aminocarboxylic acids, or heterocyclic carboxylic acids, e.g., pyridine-2,6-dicarboxylic acid (dipicolinic acid).

Exemplary commercially available chelating/sequestering agent(s) include, but are not limited to a gluconic acid salt (such as sodium gluconate (e.g. granular)) and sodium tripolyphosphate (available from lnnophos); the aminocarboxylate Trilon® M available from BASF; Versene® 100, Low NTA Versene®, Versene® Powder, and Versenol® 120 all available from Dow; Dissolvine® D-40 and GL-38 available from Akzo; and sodium citrate.

In a most preferred embodiment, the chelating/sequestering agent comprises sodium gluconate.

In preferred embodiments of the compositions organic chelating/sequestering agent(s) may be used. Organic chelating/sequestering agent(s) include both polymeric and small molecule chelating/sequestering agent(s). Organic small molecule chelating/sequestering agent(s) are typically organocarboxylate compounds or organophosphate chelating/sequestering agent(s). Polymeric chelating/sequestering agent(s) commonly include polyanionic compositions such as polyacrylic acid compounds, carboxy-methylated polyethyleneimine compounds, and mixtures thereof. In a most preferred embodiment, the detergent composition comprises a polymeric chelating/sequestering agent.

Small molecule organic chelating/sequestering agent(s) include aminocarboxylic acid type sequestrant. Suitable aminocarboxylic acid type sequestrants include the acids or alkali metal salts thereof, e.g., amino acetates and salts thereof. Suitable aminocarboxylates include N-hydroxyethylaminodiaceticacid; hydroxyethylenediaminetetraacetic acid, nitrilotriacetic acid (NTA); ethylenediaminetetraacetic acid (EDTA); N-hydroxyethyl-ethylenediaminetriacetic acid (HEDTA); diethylenetriaminepenta-acetic acid (DTPA); ethylenediamine-tetraproprionic acid triethylenetetraaminehexaacetic acid (TTHA), and alanine-N,N-diacetic acid; glutamic acid, N,N-diacetic acid (GLDA), methylglycinediacetic acid (MGDA), iminodisuccinate (IDS) and the like, and the respective alkali metal, ammonium and substituted ammonium salts thereof, and mixtures thereof. In a preferred embodiment, the detergent composition comprises methylglycinediacetic acid.

Aminophosphonates are also suitable for use as chelating/sequestering agent(s) and include ethylenediaminetetramethylene phosphonates, nitrilotrismethylene phosphonates, and diethylenetriamine-(pentamethylene phosphonate) for example. These aminophosphonates commonly contain alkyl or alkenyl groups with less than 8 carbon atoms. Preferably, the sequestrant includes phosphonic acid or phosphonate salt. Suitable phosphonic acids and phosphonate salts include 1-hydroxy ethylidene-1,1-diphosphonic acid (CH₃C(P0₃H₂)20 H) (HEDP); ethylenediamine tetrakis methylenephosphonic acid (EDTMP); diethylenetriamine pentakis methylenephosphonic acid (DETPMP); cyclohexane-1,2-tetramethylene phosphonic acid; amino[tri(methylene phosphonic acid)]; (ethylene diamine[tetra methylene-phosphonic acid)]; 2-phosphono butane-1,2,4-tricarboxylic acid; or salts thereof, such as the alkali metal salts, ammonium salts, or alkyloyl amine salts, such as mono, di, or tetra-ethanolamine salts; picolinic, dipicolinic acid or mixtures thereof.

Commercially available chelating agents include phosphonates sold under the trade name DEQUEST® from Italmatch or Cublen® from Zschimmer & Schwarz or Briquest® from Solvay including, for example, 1-hydroxyethylidene-1,1-diphosphonic acid, as DEQUEST® 2010; amino(tri(methylenephosphonic acid)), 5 (N[CH2PO3H2b), available from Italmatch as DEQUEST® 2000 or from Zschimmer & Schwarz as Cublen® AP5 or from Solvay as Briquest® 301-50A; ethylenediamine[tetra(methylenephosphonic acid)] available from Italmatch as DEQUEST® 2041; diethylenetriamine penta(methylenephosphonic acid) available as DEQUEST® 2066 from Italmatch or as Cublen® D from Zschimmer & Schwarz, and 2-phosphonobutane-1,2,4-tricarboxylic acid available from Lanxess as Bayhibit® AM.

Other suitable chelating/sequestering agent(s) include water soluble polycarboxylate polymers. Such homopolymeric and copolymeric chelating/sequestering agent(s) include polymeric compositions with pendant (—CO2H) carboxylic acid groups and include polyacrylic acid, polymethacrylic acid, polymaleic acid, acrylic acid-methacrylic acid copolymers, acrylic-maleic copolymers, hydrolyzed polyacrylamide, hydrolyzed methacrylamide, hydrolyzed acrylamide-methacrylamide copolymers, hydrolyzed polyacrylonitrile, hydrolyzed polymethacrylonitrile, hydrolyzed acrylonitrile methacrylonitrile copolymers, polymaleic acid, polyfumaric acid, copolymers of acrylic and itaconic acid, phosphine polycarboxylate, acid or salt forms thereof, or mixtures thereof. Water soluble salts or partial salts of these polymers or copolymers such as their respective alkali metal (for example, sodium or potassium) or ammonium salts can also be used. The weight average molecular weight of the polymers is from about 4000 to about 90,000. An example of commercially available polycarboxylic acids (polycarboxylates) is ACUSOL® 445 which is a homopolymer of acrylic acid with an average molecular weight of 4500 (Dow Chemicals). ACUSOL® 445 is available as partially neutralized, liquid detergent polymer. Sokalan® CP 5 is an acrylic acid/maleic acid copolymer available from BASF with a mean molar mass of 70000 g/mol.

In preferred embodiments, the total amount of chelating/sequestering agent(s) present in the composition of the present application is from about 0.1 wt. % to about 20 wt. %, more preferred from about 0.5 wt. % to about 12 wt. %, furthermore preferred from about 1 wt. % to about 12 wt. %, particularly preferred from about 5 wt. % to about 12 wt. % and most preferred from 5 wt. % to about 10 wt. %. It is furthermore preferred, that the amount of chelating/sequestering agent(s) being polycarboxylate polymers in the composition of the present application is from about 0.1 wt. % to about 5 wt. %, more preferred from about 0.5 wt. % to about 5 wt. % and particularly preferred from about 1 wt. % to about 5 wt. %. More preferred, the total amount of chelating/sequestering agent(s) present in the composition of the present application is from about 1 wt. % to about 12 wt. %, wherein the amount of chelating/sequestering agent(s) being polycarboxylate polymers in the composition of the present application is from about 0.5 wt. % to about 5 wt. %. Most preferred, the total amount of chelating/sequestering agent(s) present in the composition of the present application is from about 1 wt. % to about 10 wt. %, wherein the amount of chelating/sequestering agent(s) being polycarboxylate polymers in the composition of the present application is from about 0.5 wt. % to about 5 wt. %.

It should be noted that these ingredients can at times be provided in solutions such that the active concentration is less than the weight percentage. For example, if a 45% active concentration is employed at a 10 wt. %, only 4.5% active concentration of a chelating/sequestering agent is in the compositions. In a preferred embodiment, the active concentration of chelating/sequestering agent is between about 0.1% active concentration and about 20% active concentration, more preferably between 1% active concentration and about 20% active concentration, still most preferably between about 5% active concentration and about 20% active concentration of chelating/sequestering agent.

### Defoamer

Any suitable defoamer may be used as part of the composition, including, without limitation, silica and silicones; aliphatic acids or esters; alcohols; sulfates or sultanates; amines or amides; halogenated compounds such as fluorochlorohydrocarbons; vegetable oils, waxes, mineral oils as well as their sulfonated or sulfated derivatives; fatty acids and/or their soaps such as alkali, alkaline earth metal soaps; and phosphates and phosphate esters such as alkyl and alkaline diphosphates, and tributyl phosphates among others; and mixtures thereof.

One of the more effective antifoaming agents includes silicones. Silicones such as dimethyl silicone, glycol polysiloxane, methylphenol polysiloxane, trialkyl or tetralkyl silanes, hydrophobic silica defoamers and mixtures thereof can all be used in defoaming applications. Commercial defoamers commonly available include silicones such as Ardefoam® from Armour Industrial Chemical Company which is a silicone bound in an organic emulsion; Foam Kill® or Kresseo® available from Krusable Chemical Company which are silicone and non-silicone type defoamers as well as silicone esters; and Anti-Foam A® and DC-200 from Dow Corning Corporation. These defoamers can be present at a concentration range from about 0.00 wt. % to about 10 wt. %, from about 0.01 wt. % to about 20 wt. %, from about 0.01 wt. % to about 5 wt. %, from about 0.01 wt. % to about 4 wt. %, from about 0.01 wt. % to about 3 wt. %, from about 0.01 wt. % to about 2 wt. %, from about 0.01 wt. % to about 1.5 wt. %, or from about 0.01 wt. % to about 1 wt. %.

Other defoamers that can be used in preferred embodiments of the application include organic amides such as Antimussol® from Clariant or oil and/or polyalkylene based compounds such as Agitan® from Munzing or branched fatty alcohols such as Lsofol® from Sasol.

The compositions of the present application may further include antifoaming agents or defoaming agents which are based on alcohol alkoxylates that are stable in alkaline environments and are oxidatively stable. To this end one of the more effective antifoaming agents are the alcohol alkoxylates having an alcohol chain length of about C₈-C₁₂, and more specifically C₉-C₁₁, and having poly-propylene oxide alkoxylate in whole or part of the alkylene oxide portion. Commercial defoamers commonly available of this type include alkoxylates such as the BASF Degressal's; especially Degressal SD20. Furthermore, so-called cloud point defoamers (typically nonionic surfactants consisting of ethoxylated/propoxylated alcohols) may be used in the present application such as Plurafac® types from BASF or Dehypon® types from BASF.

### Rheology Modifiers

The compositions of the present application include a rheology modifier, preferably an acrylic polymer, copolymer, and/or homopolymer. Suitable thickeners include synthetic materials, for example, polyacrylates, polyacrylamides, polyalkylene glycols and derivatives including polyethylene glycols or polypropylene glycols, polyvinyl derivatives such as polyvinyl alcohols and/or polyvinyl acetates, or co-polymers thereof, and other polyvinyl derivatives, and mixtures thereof. Polycarboxylic acids are also useful as thickening agents in compositions of the application. ACUSOL® 445 is a partially neutralized, liquid detergent polymer. Other polyacrylic acids of molecular weight 4500 (CRITERION 2005) and 8000 (CRITERION 2108) can be purchased from Kemira Chemicals, Kennesaw, Ga. Other thickening agents include, but are not limited to, Sokalan CP5 available from BASF, Coatex DE185, Dispersant HN44, Acusol® types from Dow Chemicals such as Acusol® 805S or Acusol® 830.

In an embodiment, the rheology modifier comprises a copolymer of Formula (I):

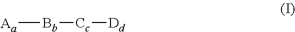

wherein A represents units of ethylenically unsaturated monomer(s) having a carboxylic acid group, wherein a represents the percent by weight (wt. %) of the monomer A on the basis of the total weight of the monomer units; and wherein B represents units of ethylenically unsaturated monomer(s) not having a carboxylic acid group, wherein b represents the percent by weight (wt. %) of the monomer B on the basis of the total weight of the monomer(s); and wherein C represents an ethylenically unsaturated oxyalkylated monomer terminated by a hydrophobic fatty chain having at least 26 C atoms, wherein c represents the percent by weight (wt. %) of the monomer on the basis of the total weight of the monomer(s). Component D is optional and if included in the copolymer preferably comprises unit(s) of at least one monomer having at least two sites of ethylenic unsaturation such as ethylene glycol dimethacrylate, 2,2-dihydroxymethylbutanol triacrylate, allyl acrylate, methylenebis(meth)acrylamide, tetraallyloxyethane, the triallyl cyanuratas, and the various allyl ethers obtained from polyols such as pentaerythritol, sorbitol, sucrose, or others.

In accordance with Formula (I), component A comprises units of at least one ethylenically unsaturated monomer and having one or more carboxylic acid groups, which monomer is selected from among the monoacids such as acrylic, methacrylic, crotonic, isocrotonic, and cinnamic acid; the diacids such as itaconic, fumaric, maleic, and citraconic acids; the anhydrides of carboxylic acids such as maleic anhydride, and the hemiesters of diacids, such as the C₁-C₄ monoesters of maleic and itaconic acid, with the preferred ethylenically unsaturated carboxyl-group-containing (carboxylated) monomer being acrylic acid, methacrylic acid, or iraconic acid.

In accordance with Formula (I), component B comprises, optionally, unit(s) of at least one ethylenically unsaturated monomer not having a carboxylic acid group, selected in a non-limiting manner from the group consisting of esters of (meth)acrylic acid such as methyl, ethyl, butyl, or 2-ethylhexyl (meth)acrylate, or from the group consisting of acrylonitrile, vinyl acetate, styrene, methylstyrene, diisobutylene, vinylpyrrolidone, and vinylcaprolactam; preferably with the ethylenically unsaturated non-carboxylated monomer being selected from the group consisting of acrylic esters such as the C₁-C₄-alkyl (meth)acrylates.

Further in accordance with Formula (I), component C comprises units of at least one monomer according to the formula (C), which is an oxyalkylated monomer having ethylenic unsaturation and which is terminated by a hydrophobic fatty chain.

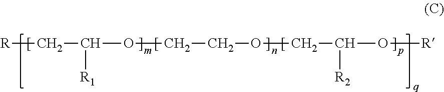

wherein m and p represent the number of oxyalkylene groups, each ≤100; n represents the number of oxyethylene groups ≤100, q represents an integer of at least 1, such that q(n+m+p)≤100; wherein R represents an unsaturated polymerizable group, wherein the unsaturated polymerizable group is a vinyl group containing moieties, methacryloyl, maleoyl, itaconoyl, crotonyl, an unsaturated urethane moiety, hemiester maleoyl, hemiester itaconoyl, CH₂═CHCH₂—O—, methacrylamido and substituted methacrylamide; wherein R′ represents a hydrophobic group with a fatty chain having at least 26 C atoms, including without limitation an alkyl, alkylaryl, aralkyl, or aryl group, linear or branched, or wherein R′ represents a linear or branched hydrophobic alkyl group with at least 28 C atoms, and wherein the number of oxyalkylene groups is between about 10-70; wherein R₁ represents hydrogen or a methyl group; and wherein R₂ represents hydrogen or a methyl group.

In an embodiment, the vinyl group containing moiety of R is preferably a member selected from the group consisting of acrylolyl, a vinylphthaloyl, a hemiester phthaloyl, acrylamide and a substituted acrylamide, and the unsaturated urethane moiety is preferably (meth)acrylurethane, α,α-dimethyl-m-isopropenylbenzylurethane or allylurethane.

In accordance with Formula (I), component D comprises, optionally, unit(s) of at least one monomer having at least two sites of ethylenic unsaturation such as ethylene glycol dimethacrylate, 2,2-dihydroxymethylbutanol triacrylate, allyl acrylate, methylenebis(meth)acrylamide, tetraallyloxyethane, the triallyl cyanuratas, and the various allyl ethers obtained from polyols such as pentaerythritol, sorbitol, sucrose, or others.

The copolymer according to Formula (I) preferably comprises between about 5 wt. % to about 98 wt. % and preferably between about 20 wt. % to about 50 wt. % units of ethylenically unsaturated monomers having at least one carboxylic acid group; between about 0 wt. % to about 83 wt. % and preferably between about 47 and about 77 wt. % unit(s) of other monomer(s) having ethylenic unsaturation and not having any carboxylic acid groups; between about 2 wt. % to about 18 wt. % and preferably between about 3 wt. % to about 10 wt. % units of the monomer according to Formula (C); and between about 0 wt. to about 5 wt. %, preferably between about 0 wt. % to about 3 wt. % unit(s) of monomer(s) having at-least two sites of ethylenic unsaturation; wherewith the total of components (a.)+(b.)+(c.)+(d.)=100 wt. 0.

Further discussion of acrylic copolymers suitable for use as rheology modifiers can be found in U.S. Pat. No. 5,362,415, which is herein incorporated by reference in its entirety.

In a further embodiment, the rheology modifier is a polymer comprising the reaction product of (A) between about 1 wt. % to about 99.8 wt. % of one or more nonionic, cationic, anionic, or amphoteric monomers; (B) between about 0 wt. % to about 98.8 wt. % of one or more monoethylenically unsaturated monomers different from (A); (C) between about 0.1 wt. % to about 98.8 wt. % of one or more monoethylenically unsaturated macromonomers different from (A) and (B); (D) between about 0.1 wt. % to about 98.8 wt. % of one or more monoethylenically unsaturated macromonomers different from (A)-(C); (E) between about 0.0 wt. % to about 20 wt. % or greater of one or more polyethylenically unsaturated monomers different from (A)-(D); and (F) between about 0 wt. % to about 25 wt. % or greater of one or more acrylates and/or methacrylates derived from a strong acid or a salt of a strong acid different from components (A)-(E).

In a preferred embodiment, component (A) comprises one or more alpha, beta-monoethylenically unsaturated carboxylic acids. Various carboxylic acid monomers can be used, such as acrylic acid, methacrylic acid, ethacrylic acid, alpha-chloroacrylic acid, crotonic acid, fumaric acid, citraconic acid, mesaconic acid, itaconic acid, maleic acid and the like including mixtures thereof. Methacrylic acid is preferred. A large proportion of carboxylic acid monomer is useful in providing a polymeric structure which will solubilize and provide a thickener when reacted with an alkali like sodium hydroxide.

Component (B) comprises one or more monoethylenically unsaturated monomers. The preferred monomers provide water insoluble polymers when homopolymerized and are illustrated by acrylate and methacrylate esters, such as ethyl acrylate, butyl acrylate or the corresponding methacrylate. Other monomers which can be used are styrene, alkyl styrenes, vinyl toluene, vinyl acetate, vinyl alcohol, acrylonitrile, vinylidene chloride, vinyl ketones and the like. Nonreactive monomers are preferred, those being monomers in which the single ethylenic group is the only group reactive under the conditions of polymerization. However, monomers which include groups reactive under baking conditions or with divalent metal ions such as zinc oxide may be used in some situations, like hydroxyethyl acrylate.

Component (C) comprises a macromonomer according to Formula (C₁):

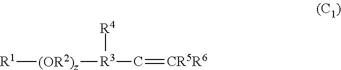

wherein R¹ is a monovalent residue of a substituted or unsubstituted complex hydrophobe compound; each R² is the same or different and is a substituted or unsubstituted divalent hydrocarbon residue; R³ is a substituted or unsubstituted divalent hydrocarbon residue; R⁴, R⁵ and R⁶ are the same or different and are hydrogen or a substituted or unsubstituted monovalent hydrocarbon residue; and z is a value of 0 or greater.

Component (D) comprises a macromonomer according to Formula (D):

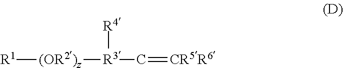

wherein: R^{1′} is a monovalent residue of a substituted or unsubstituted hydrophobe compound other than a complex hydrophobe compound; each R^{2′} is the same or different and is a substituted or unsubstituted divalent hydrocarbon residue; R^{3′} is a substituted or unsubstituted divalent hydrocarbon residue; R^{4′}, R^{5′} and R^{6′} are the same or different and are hydrogen or a substituted or unsubstituted monovalent hydrocarbon residue; and z′ is a value of 0 or greater.

Further discussion of suitable thickening polymers is found in U.S. Pat. No. 5,639,841, which is herein incorporated by reference in its entirety. Further suitable rheology modifiers and methods of making thereof are found in U.S. Application No. 2005/0159568 and U.S. Pat. Nos. 5,891,972 and 5,066,710, which are herein incorporated by reference in their entirety.

In an embodiment, the thickener comprises an aqueous suspension comprising a homopolymer of acrylic acid, a water-soluble copolymer of acrylic acid with one or more acrylic, vinyl or allylic monomers, or both the homopolymer and the copolymer, wherein the homopolymer or copolymer has a molecular weight corresponding to a viscosity index with a value from 0.08 to 0.80, and wherein said mineral particles are derived from mechanical reconcentration, thermal reconcentration, or both mechanical and thermal reconcentration after wet grinding in the absence of a dispersant at low concentrations of dry matter. In this embodiment, the homopolymer of acrylic acid is provided in a form partially neutralized or totally neutralized by one or more neutralizing agents having a monovalent function containing an alkaline cation, and optionally by one or more neutralizing agents having a polyvalent function containing an alkaline-earth divalent cation, or a compound containing a higher-valency cation. In this embodiment, the water-soluble copolymer of acrylic acid comprises one or more acrylic, vinyl or allylic monomers which are partially neutralized or totally neutralized by one or more neutralizing agents having a monovalent function containing an alkaline cation, or optionally by one or more neutralizing agents having a polyvalent function containing an alkaline-earth divalent cation, or a compound containing a higher-valency cation. Further discussion of suitable water soluble thickening agents can be found in U.S. Pat. No. 6,767,973, which is herein incorporated by reference in its entirety.

In a further embodiment, the thickener may include (1) a copolymer of at least one monomer of the formula II):

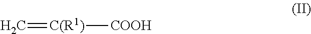

wherein R¹ is a linear or branched C₁-C₆ alkyl or phenyl group; and (2) at least one monomer of (meth)acrylic acid (C₁-C₆) alkyl or phenyl ester. Additionally or in alternative to this copolymer, the thickener may include a copolymer of (1) acrylic and/or methacrylic acid; (2) at least one monomer of the formula (III):

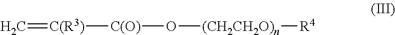

wherein R³ is H or CH₃, n is at least 2 and has an average value of at least 10, and R⁴ is a hydrophobic group containing 8 to 24 carbon atoms; and (3) at least one monomer of C₁-C₄ alkyl (meth)acrylate. Further discussion of suitable polymer systems can be found in U.S. Pat. No. 9,752,109, which is herein incorporated by reference in its entirety.

In a preferred embodiment, the thickener comprises an acrylic copolymer, such as Rheosolve® T 633, commercially available from Coatex.

In addition to the aforementioned acrylic polymers, further suitable thickeners may be includd as needed, for example natural gums such as xanthan gum, guar gum, or other gums from plant mucilage; polysaccharide-based thickeners, such as alginates, starches, and cellulosic polymers (e.g., carboxymethyl cellulose); polyacrylates thickeners; and hydrocolloid thickeners, such as pectin.

In some embodiments, the thickener included is non oxidizable and storage stable under the pH conditions of the application. In an embodiment, the thickener does not leave contaminating residue on the surface of an object. For example, the thickeners or gelling agents can be compatible with food or other sensitive products in contact areas. Generally, the concentration of thickener employed in the present compositions or methods will be dictated by the desired viscosity within the final composition.

According to the present application, the amount of rheology modifier within the composition ranges from about 0.001 wt. % to about 10 wt. %, from about 0.01 wt. % to about 5 wt. %, from about 0.1 wt. % to about 1.0 wt. %, or from about 0.1 wt. % to about 0.5 wt. %. In a preferred embodiment, the composition comprises between about 2 wt. % about 3.5 wt. % of a rheology modifier.

### Optical Brighteners and Whitening Agents

The detergent compositions may include an optical brightener, also referred to as a fluorescent whitening agent or a fluorescent brightening agent. Brighteners are added to laundry detergents to replace whitening agents removed during washing and to make the clothes appear cleaner. Optical brighteners may include dyes that absorb light in the ultraviolet and violet region (usually 340-370 nm) of the electromagnetic spectrum, and re-emit light in the blue region (typically 420-470 nm). These additives are often used to enhance the appearance of the color of a fabric, causing a perceived “whitening” effect, making materials look less yellow by increasing the overall amount of blue light reflected.

Fluorescent compounds belonging to the optical brightener family are typically aromatic or aromatic heterocyclic materials often containing a condensed ring system. A feature of these compounds is the presence of an uninterrupted chain of conjugated double bonds associated with an aromatic ring. The number of such conjugated double bonds is dependent on substituents as well as the planarity of the fluorescent part of the molecule. Most brightener compounds are derivatives of stilbene or 4,4′-diamino stilbene, biphenyl, five membered heterocycles (triazoles, oxazoles, imidazoles, etc.) or six membered heterocycles (naphthalamides, triazines, etc.). The choice of optical brighteners for use in compositions will depend upon a number of factors, such as the type of composition, the nature of other components present in the composition, the temperature of the wash water, the degree of agitation, and the ratio of the material washed to the tub size. The brightener selection is also dependent upon the type of material to be cleaned, e.g., cottons, synthetics, etc. Because most laundry detergent products are used to clean a variety of fabrics, the detergent compositions may contain a mixture of brighteners which are effective for a variety of fabrics. Further, it can be common to employ different temperatures based on the types of fabrics to be washed, with this in mind, it is preferable to an optical brightener effective in low temperature and high temperature wash cycles. It is of course necessary that the individual components of such a brightener mixture be compatible. In a preferred embodiment, the detergent composition contains at least two optical brighteners.

Examples of suitable optical brighteners are commercially available and will be appreciated by those skilled in the art. At least some commercial optical brighteners can be classified into subgroups, including, but are not limited to derivatives of stilbene, pyrazoline, carboxylic acid, methinecyanines, dibenzothiophene-5,5-dioxide, azoles, 5- and 6-membered-ring heterocycles, and other miscellaneous agents. Examples of particularly suitable optical brightening agents include, but are not limited to: distyryl biphenyl disulfonic acid sodium salt, cyanuric chloride/diaminostilbene disulfonic acid sodium salt. Examples of suitable commercially available optical brightening agents include, but are not limited to: Tinopal® 5 BM-GX, Tinopal® CBS-CL, Tinopal® CBS-X, Tinopal® DMS-X, Tinopal® DMA-X, and Tinopal® AMS-GX, available from BASF, and Optiblanc MTB available from 3V Sigma USA. Examples of optical brighteners are also disclosed in “The Production and Application of Fluorescent Brightening Agents,” M. Zahradnik, Published by John Wiley & Sons, New York (1982), the disclosure of which is incorporated herein by reference. Suitable stilbene derivatives include, but are not limited to derivatives of bis(triazinyl)amino-stilbene, bisacylamino derivatives of stilbene, triazole derivatives of stilbene, triazine derivatives of stilbene, oxadiazole derivatives of stilbene, oxazole derivatives of stilbene, and styryl derivatives of stilbene.

One or more optical brighteners may be used in the compositions. In some embodiments, optical brighteners are included in the compositions, individually or in sum, at an amount of from about 0.01 to about 5 wt. %, from about 0.1 wt. % to about 4 wt. %, from about 0.15 to about 3 wt. %, or from about 0.2 to about 2 wt. %.

### Additional Functional Ingredients

The compositions may include additional functional ingredients. Additional functional ingredients suitable for inclusion in the compositions include, but are not limited to, soil antiredeposition agents, antifoam agents, low foaming surfactants, defoaming surfactants, pigments and dyes, softening agents, anti-static agents, anti-wrinkling agents, dye transfer inhibition/color protection agents, odor removal/odor capturing agents, soil shielding/soil releasing agents, ultraviolet light protection agents, fragrances, sanitizing agents, disinfecting agents, water repellency agents, insect repellency agents, anti-pilling agents, souring agents, mildew removing agents, allergicide agents, and mixtures thereof.

In some embodiments, the additional functional ingredient or ingredients is formulated in the compositions. In other embodiments, the additional functional ingredient or ingredients is added separately during a cleaning process.

### Color Stabilizing Agent

The compositions optionally include a color stabilizing agent. A color stabilizing agent can be any component that is included to inhibit discoloration or browning of the composition. In some embodiments, a color stabilizing agent may be included in the compositions at an amount of from about 0.01 wt. % to about 5 wt. %, from about 0.05 wt. % to about 3 wt. %, and from about 0.10 wt. % to about 2 wt. %.

### Antiredeposition Agent

The compositions may include antiredeposition agents. Without wishing to be bound by any particular theory, it is thought that antiredeposition agents aid in preventing loosened soil from redepositing onto cleaned fabrics. Antiredeposition agents may be made from complex cellulosic materials such as carboxymethylcellulose (CMC), or synthetic materials such as polyethylene glycol and polyacrylates. In other embodiments, polyphosphate builders may be included as an antiredeposition agent.

### Bleaching Composition

As the liquid detergent concentrate composition is preferably used as a detergent for institutional and industrial washing the liquid detergent concentrate composition as such does not contain any bleaching agents. In institutional and industrial washing processes the bleaching agent is normally dosed separately from the detergent. Only in powder household detergents bleaching agents are present. The present application therefore also provides a system comprising a first component and a second component, wherein the first component is represented by the liquid detergent concentrate according to the present application and the second component is containing a bleaching composition.

In some aspects, the bleaching compositions include at least one oxidizing agent. The bleaching composition can include any of a variety of oxidizing agents, for example, hydrogen peroxide and/or any inorganic or organic peroxide or peracid. The oxidizing agent can be present at an amount effective to convert a carboxylic acid to a peroxycarboxylic acid. In some embodiments, the oxidizing agent can also have antimicrobial activity. In other embodiments, the oxidizing agent is present in an amount insufficient to exhibit antimicrobial activity.

In some embodiments, the bleaching compositions include about 0.001 wt. % oxidizing agent to about 60 wt. % oxidizing agent. In other embodiments, the compositions of the application include about 10 wt. % to about 30 wt. % oxidizing agent. Examples of inorganic oxidizing agents include the following types of compounds or sources of these compounds, or alkali metal salts including these types of compounds, or forming an adduct therewith: hydrogen peroxide, urea-hydrogen peroxide complexes or hydrogen peroxide donors of: group 1 (IA) oxidizing agents, for example lithium peroxide, sodium peroxide; group 2 (IIA) oxidizing agents, for example magnesium peroxide, calcium peroxide, strontium peroxide, barium peroxide; group 12 (IIB) oxidizing agents, for example zinc peroxide; group 13 (IIIA) oxidizing agents, for example boron compounds, such as perborates, for example sodium perborate hexahydrate of the formula Na₂[B₂(O₂)₂(OH)₄]·6H₂O (also called sodium perborate tetrahydrate); sodium peroxyborate tetrahydrate of the formula Na₂B₂(O₂)₂[(OH)₄]·4H₂O (also called sodium perborate trihydrate); sodium peroxyborate of the formula Na₂[B₂(O₂)₂(OH)₄](also called sodium perborate monohydrate); group 14 (IVA) oxidizing agents, for example persilicates and peroxycarbonates, which are also called percarbonates, such as persilicates or peroxycarbonates of alkali metals; group 15 (VA) oxidizing agents, for example peroxynitrous acid and its salts; peroxyphosphoric acids and their salts, for example, perphosphates; group 16 (VIA) oxidizing agents, for example peroxysulfuric acids and their salts, such as peroxymonosulfuric and peroxydisulfuric acids, and their salts, such as persulfates, for example, sodium persulfate; and group VIIA oxidizing agents such as sodium periodate, potassium perchlorate. Other active inorganic oxygen compounds can include transition metal peroxides; and other such peroxygen compounds, and mixtures thereof.

Examples of organic oxidizing agents include, but are not limited to, perbenzoic acid, derivatives of perbenzoic acid, t-butyl benzoyl hydroperoxide, benzoyl hydroperoxide, or any other organic based peroxide and mixtures thereof, as well as sources of these compounds. Other examples include, but are not limited to, peracids including C₁-C₂₂ percarboxylic acids such as peracetic acid, performic acid, percarbonic acid, peroctanoic acid, and the like; per-diacids or per-triacids such as peroxalic acid, persuccinic acid, percitric acid, perglycolic acid, permalic acid and the like; and aromatic peracids such as perbenzoic acid, or mixtures thereof.

The compositions of the present application may employ one or more of the inorganic oxidizing agents listed above. Suitable inorganic oxidizing agents include ozone, hydrogen peroxide, hydrogen peroxide adduct, group IIIA oxidizing agent, or hydrogen peroxide donors of group VIA oxidizing agent, group VA oxidizing agent, group VIIA oxidizing agent, or mixtures thereof. Suitable examples of such inorganic oxidizing agents include percarbonate, perborate, persulfate, perphosphate, persilicate, or mixtures thereof.

### Carboxylic and Percarboxylic Acids

The bleaching compositions of the present application may include at least one carboxylic and/or percarboxylic acid. In some embodiments, the compositions of the present application include at least two or more carboxylic and/or percarboxylic acids.

In a preferred embodiments, the carboxylic acid for use with the compositions of the present application includes a C₁ to C₂₂ carboxylic acid. Further preferred the carboxylic acid for use with the compositions of the present application is a C₁ to C₁₂ carboxylic acid. The carboxylic acid for use with the compositions of the present application in particular may be a C₅ to C₁₂ carboxylic acid. In particular preferred embodiments, the carboxylic acid for use with the compositions of the present application is a C₁ to C₄ carboxylic acid. Examples of suitable carboxylic acids include, but are not limited to, formic, acetic, propionic, butanoic, pentanoic, hexanoic, heptanoic, octanoic, nonanoic, decanoic, undecanoic, dodecanoic, as well as their branched isomers, lactic, maleic, ascorbic, citric, hydroxyacetic, neopentanoic, neoheptanoic, neodecanoic, oxalic, malonic, succinic, glutaric, adipic, pimelic subric acid, and mixtures thereof.

The bleaching compositions of the present application preferably include about 0.1 wt. % to about 80 wt. % of a carboxylic acid. In other embodiments, the compositions of the present application include about 1 wt. % to about 60 wt. % of a carboxylic acid. In yet other embodiments, the compositions of the present application include about 20 wt. %, about 30 wt. %, or about 40 wt. % of a carboxylic acid. In further preferred embodiments, the compositions of the present application include about 5 wt. % to about 10 wt. % of acetic acid. In other embodiments, the compositions of the present application include about 5 wt. % to about 10 wt. % of octanoic acid. Further preferred, the bleaching compositions of the present application include a combination of octanoic acid and acetic acid.

The bleaching compositions of the present application preferably include at least one peroxycarboxylic acid. Peroxycarboxylic acids useful in the bleaching compositions include peroxyformic, peroxyacetic, peroxypropionic, peroxybutanoic, peroxypentanoic, peroxyhexanoic, peroxyheptanoic, peroxyoctanoic, peroxynonanoic, peroxydecanoic, peroxyundecanoic, peroxydodecanoic, or the peroxyacids of their branched chain isomers, peroxylactic, peroxymaleic, peroxyascorbic, peroxyhydroxyacetic, peroxyoxalic, peroxymalonic, peroxysuccinic, peroxyglutaric, peroxyadipic, peroxypimelic and peroxysubric acid and mixtures thereof. The bleaching compositions may utilize a combination of several different peroxycarboxylic acids. For example, in some embodiments, the composition includes one or more C₁ to C₄ peroxycarboxylic acids and one or more C₅ to C₁₂ peroxycarboxylic acids. In some embodiments, the C₁ to C₄ peroxycarboxylic acid is peroxyacetic acid and the C₅ to C₁₂ acid is peroxyoctanoic acid.

In preferred embodiments, the bleaching compositions include peroxyacetic acid. Peroxyacetic (or peracetic) acid is a peroxycarboxylic acid having the formula CH₃COOOH. Generally, peroxyacetic acid is a liquid having an acrid odor at higher concentrations and is freely soluble in water, alcohol, ether, and sulfuric acid. Peroxyacetic acid can be prepared through any number of methods known to those of skill in the art including preparation from acetaldehyde and oxygen in the presence of cobalt acetate. A solution of peroxyacetic acid can be obtained by combining acetic acid with hydrogen peroxide. A 50% solution of peroxyacetic acid can be obtained by combining acetic anhydride, hydrogen peroxide and sulfuric acid.

In preferred embodiments, the bleaching compositions include peroxyoctanoic acid, peroxynonanoic acid, or peroxyheptanoic acid. In further preferred embodiments, the bleaching compositions include peroxyoctanoic acid. Peroxyoctanoic (or peroctanoic) acid is a peroxycarboxylic acid having the formula, for example, of n-peroxyoctanoic acid: CH₃(CH₂)₅COOOH. Peroxyoctanoic acid can be an acid with a straight chain alkyl moiety, an acid with a branched alkyl moiety, or a mixture thereof. Peroxyoctanoic acid can be prepared through any number of methods known to those of skill in the art. A solution of peroxyoctanoic acid can be obtained by combining octanoic acid and hydrogen peroxide and a hydrotrope, solvent or carrier.

Further preferred, the bleaching compositions include about 0.1 wt. % to about 90 wt. % of one or more peroxycarboxylic acids. In other embodiments, the bleaching compositions include about 1 wt. % to about 25 wt. % of one or more peroxycarboxylic acids.

In yet other embodiments, the bleaching compositions include about 5 wt. % to about 10 wt. % of one or more peroxycarboxylic acids. In some embodiments, the bleaching compositions include about 1 wt. % to about 25 wt. % of peroxyacetic acid. In other embodiments, the bleaching compositions include about 0.1 wt. % to about 10 wt. % of peroxyoctanoic acid. In still yet other embodiments, the bleaching compositions include a mixture of about 5 wt. % peroxyacetic acid, and about 1.5 wt. % peroxyoctanoic acid.

Further preferred, the peracid is selected from peracetic acid, perpropionic acid, peroctanoic acid, phthalimidoperhexanoic acid, phthalimidoperoctanoic acid, persuccinic acid, persuccinic acid monomethyl ester, perglutaric acid, perglutaric acid monomethyl ester, peradipic acid, peradipic acid monomethyl ester, persuccinic acid, and persuccinic acid monomethyl ester.

In a further preferred embodiment the bleaching composition comprises from about 1 wt. % to about 30 wt. % of peracid. Further preferred, the bleaching composition additionally contains from about 0.01 wt. % to about 35 wt. % of hydrogen peroxide. Still further preferred, the bleaching composition comprises at least a mixture of hydrogen peroxide, peracid and the corresponding acid. Most preferred, the bleaching composition comprises at least hydrogen peroxide, peroxyacetic acid and acetic acid.

### Antimicrobial Agents

The composition may further include one or more antimicrobial agents. The one or more antimicrobial agent may comprise a peracid with antimicrobial capacity, as described herein. Additionally or alternatively, the antimicrobial agent may comprise an antimicrobial cationic surfactant, such as an antimicrobial quaternary ammonium compound. When utilized, the antimicrobial agent may be present in amounts of between about 0 wt. % to about 25 wt. %, from about 0.001 wt. % to about 20 wt. %, from about 0.01 wt. % to about 15 wt. %, from about 0.1 wt. % to about 10 wt. %, or from about 1 wt. % to about 5 wt. %.

### Methods of Use

The detergent compositions are suited for various applications of use. Laundry and textile detergents are a particularly preferred application of use for the compositions. The method for washing textiles comprises providing the liquid detergent concentrate composition, diluting the liquid detergent concentrate composition to a stable aqueous use solution in a concentration of about 0.5 wt. % to about 25 wt. %, preferably about 1 wt. % to about 10 wt. %, and most preferably between about 0.05 wt. % at 1 wt. % based on the whole use solution, optionally adding a bleaching composition to the liquid detergent concentrate composition or to the use solution, and washing the textiles in an institutional or household washing machine in the use solution.

Additional cleaning applications, can be employed where there is a need for a rheology modifier package to provide built detergent formulations containing nonionic surfactants and alkalinity sources and/or builders. For example, detergent compositions for hard surface cleaning, membrane cleaning, paper processing and/or water treatment, and various laundry applications can be employed. It is desirable for the detergent compositions to be uniformly dispensed using conventional dispensing, such as pumps, due to the rheology modifier package employed.

The detergent compositions can be applied to surfaces using a variety of methods. These methods can operate on an object, surface, or the like, by contacting the object or surface with the detergent composition. Contacting can comprise any of numerous methods for applying a viscous liquid, such as pumping the composition for further use and/or dilution of a concentrate, immersing the object in the composition, foam or gel treating the object with the composition, or a combination thereof. Without being limited to the contacting according to the application, a concentrate or use liquid composition can be applied to or brought into contact with an object by any conventional method or apparatus for applying a viscous liquid composition to an object. For example, the surface can be wiped with, sprayed with, foamed on, and/or immersed in the liquid compositions, or use liquid compositions made from the concentrated liquid compositions. The liquid compositions can be sprayed, foamed, or wiped onto a surface; the compound can be caused to flow over the surface, or the surface can be dipped into the compound. Contacting can be manual or by machine.

The detergent compositions are in contact with a surface or object for a sufficient amount of time to clean the surface or object. In an aspect, the surface or object is contacted with the detergent composition for at least about 1 minute, or at least about 10 minutes. The detergent compositions can be applied at a use or concentrate solution to a surface or object in need of cleaning.

All publications and patent applications in this specification are indicative of the level of ordinary skill in the art to which this application pertains. All publications and patent applications are herein incorporated by reference to the same extent as if each individual publication or patent application was specifically and individually indicated as incorporated by reference.

### EXAMPLES

Embodiments of the present application are further defined in the following non-limiting Examples. It should be understood that these Examples, while indicating certain embodiments of the application, are given by way of illustration only. From the above discussion and these Examples, one skilled in the art can ascertain the essential characteristics of this application, and without departing from the spirit and scope thereof, can make various changes and modifications of the embodiments of the application to adapt it to various usages and conditions. Thus, various modifications of the embodiments of the application, in addition to those shown and described herein, will be apparent to those skilled in the art from the foregoing description. Such modifications are also intended to fall within the scope of the appended claims.

The following materials were employed:
Trilon M—aminocarboxylic acid chelant
Trilon P—a carboxy-methylated polyethyleneimine
Acusol 445/445N—Acrylic polymer (4500 MW)
Belclene 200—Polymaleic acid polymer
Tinopal CBS-X—4,4′-Distyryl biphenyl derivative
Tinopal DMS-X—bis-(triazinylamino)-stilbene disulphonic acid derivative
Optiblanc MTB—Disodium 2,2′-ethene-1,2-diylbis[5-((4-anilino-6-[(2-hydroxyethyl)(methyl)amino]-1,3,5-triazin-2-yl)amino)benzenesulfonate]
Dequest 2066—diethylenetriamine penta(methylene phosphonic acid)
Lutensol TO 8—saturated iso-C₁₃ alcohol nonionic surfactant
Lutensol AO3/AO7—a C₁₃₋₁₅ fatty alcohol ethoxylate
Rheosolve T 633—acrylic copolymer
Sokalan CP5—copolymer of maleic acid and acrylic acid
Dehypon LS54—a C₁₂₋₁₄ fatty alcohol ethoxylate/propoxylate
Sodium Hydroxide—alkalinity source
Sodium Gluconate—chelating agent

### Example 1

The storage stability of a concentrated detergent composition was tested. The liquid detergent concentrate compositions were prepared according to Table 2, utilizing low concentrations of an acrylic copolymer for assessing impact on stability of the concentrated detergent composition (emulsion), which was added without the use of a premix. The compositions were then stored for several days until separation was observed.

TABLE 2

| | Quantity |
|---|---|
| Component | (wt. %) |
| Rheosolve T 633 | 1.00 |
| CBSX | 0.1-0.2 |
| DMS-X | 0.5-1.0 |
| NaOH (50%) | 25-40 |
| Dequest 2066 | 3-7 |
| Acusol 445 | 1-3 |
| Trilon M | 3-7 |
| Lutensol TO8 | 15-20 |
| Water | To 100 |

After two days greater than 10% separation of the components was observed. These results demonstrate unacceptable stability. Therefore, additional testing was completed.

### Example 2

In order to further improve the stability of the compositions, the quantity of the acrylic copolymer thickener was increased in comparison to testing in Example 1. The compositions were again prepared without the use of a premix according to Table 3. After preparation, the compositions were subjected to viscosity analysis and a separation analysis.

TABLE 3

| Component | Quantity (wt. %) |
|---|---|
| Rheosolve T 633 | 3.00 |
| CBSX | 0.1-0.2 |
| DMS-X | 0.5-1.0 |
| NaOH (50%) | 25-40 |
| Dequest 2066 | 3-7 |
| Acusol 445 | 1-3 |
| Trilon M | 3-7 |
| Lutensol TO8 | 15-20 |
| Water | To 100 |

Viscosity was assessed using a Brookfield viscometer, which measures viscosity through a spring using a cylinder rotating in the fluid sample. The torque required to turn the cylinder in the liquid is a function of the liquid's viscosity. Using a digital viscometer, the instrument was leveled, turned on, and zeroed. A sample of the composition was then transferred into an appropriately sized beaker. The spindle of the viscometer was then placed into the sample, and both were attached to the viscometer. Appropriate height and speed were selected. The viscometer was then run until the reading stabilized, generally about one minute. Viscosity was then recorded in milli Pascal seconds (mPas). Viscosity was considered suitable if the viscosity was less than 1000 mPas.

The compositions were additionally subjected to a storage test for liquid detergents. According to this test method, the storage behavior of samples of the compositions were evaluated at a range of temperatures (including room temperature), and in varying light conditions (i.e. daylight and the dark). The liquid compositions were kept for three months at −5° C., 5° C., room temperature, and 40° C. Additionally, the compositions were subjected to three freeze-thaw cycles, wherein the sample was frozen at −5° C. and thawed at 40° C. The samples were visually assessed twice a month, recording appearance including gelation, precipitation, flocculation, turbidity, phase separation, and color.

Phase separation was measured in millimeters based on a measurement of the bottom of the beaker to the top of the separated later, and the bottom of the beaker to the total height of the sample. recorded and expressed as a percentage of the total sample content, according to the formula:

$$\% Separation = ( precipitation ( cm ) / total event ( cm ) ) * 100$$

Separation, such as precipitation, phase separations, etc. were deemed acceptable if the percent separation was not greater than 10% within the three-month storage period. The results of these tests are shown in Tables 4 and 5.

TABLE 4
Stability (% Separation)

| | Day | Room Temperature Sample | 40° C. Sample |
|---|---|---|---|
| 2 | weeks | 0% | 0% |
| 6 | weeks | 0% | 0% |
| 8 | weeks | 0% | 2.1% |
| 10 | weeks | 0% | 2.2% |
| 13 | weeks | 0% | 2.2% |

TABLE 5
Viscosity (mPas) (sp. 2, 20 rpm)

| | Day | Room Temperature (20° C.) Sample |
|---|---|---|
| 1 | day | 428 |
| 1 | week | 790 |
| 6 | weeks | 858 |
| 8 | weeks | 820 |
| 10 | weeks | 768 |
| 13 | weeks | 582 |

These data show excellent storage capability across a wide range of temperature conditions. Separation was at most 2.2%, well below the 10% threshold of acceptability.

Further, viscosity was no greater than 858 mPas, again well below the 1000 mPas threshold of acceptability.

### Example 3

To further evaluate the impact of the acrylic copolymer thickener, compositions were prepared with increasing concentrations of the thickener, according to Table 6. The compositions were then evaluated using the procedure described in Example 2.

TABLE 6

| | Formulation A | Formulation B |
|---|---|---|
| Component | Qty (wt. %) | Qty (wt. %) |
| Rheosolve T 633 | 3.20 | 3.35 |
| CBSX | 0.1-0.2 | 0.1-0.2 |
| DMS-X | 0.5-1.0 | 0.5-1.0 |
| NaOH (50%) | 25-40 | 25-40 |
| Dequest 2066 | 3-7 | 3-7 |
| Acusol 445 | 1-3 | 1-3 |
| Trilon M | 3-7 | 3-7 |
| Lutensol TO8 | 15-20 | 15-20 |
| Water | To 100 | To 100 |

The results of the Brookfield viscosity analysis and degree of separation test are shown in Tables 7 and 8, respectively.

TABLE 7
Stability (% Separation)

| | | Formulation A | | Formulation B | |
|---|---|---|---|---|---|
| Day | | RT (20° C.) | 40° C. | RT (20° C.) | 40° C. |
| 1 | week | | | 0% | 0% |
| 3 | weeks | 0% | 2% | | |
| 4 | weeks | | | 0% | 0% |
| 5 | weeks | 0% | 2% | | |
| 6 | weeks | | | | |
| 7 | weeks | 2.2% | 4.3% | 0% | 0% |
| 10 | weeks | 2.2% | 4.4% | 0% | 0% |
| 11 | weeks | | | | |
| 13 | weeks | 2.2% | 6.4% | | |

These data show excellent stability over the course of approximately 13 weeks. Formulation A illustrated minimal separation at 40° C., while Formulation B demonstrated 0% separation. The data show the compositions are very stable under a wide range of temperatures.

TABLE 8
Viscosity (mPas) (sp. 2, 20 rpm)

| Time | | RT (20° C.) | RT (20° C.) |
|---|---|---|---|
| 1 | day | 546 | |
| 2 | days | | 788 |
| 1 | week | | 706 |
| 3 | weeks | 694 | |
| 4 | weeks | | 814 |
| 5 | weeks | 676 | |
| 6 | weeks | | |
| 7 | weeks | 662 | |
| 10 | weeks | 660 | 790 |
| 11 | weeks | | |
| 13 | weeks | 654 | |

Table 8 shows that Formulations A and B achieve the desired viscosity, as none of the compositions had a viscosity in excess of 1000 mPas. These results show that the compositions of the present application successfully achieve a desirable level of stability while maintaining a preferred viscosity.

### Example 4

The compositions of the application were also prepared using a premix comprising the acrylic copolymer thickener. A premix may be used to further facilitate uniformity of the liquid composition, i.e. minimizing any lumps or inconsistencies in the materials. The compositions were prepared as shown in Table 9. The compositions were then evaluated using the procedure described in Example 2.

TABLE 9

| | | Formulation C | Formulation D |
|---|---|---|---|
| Component | | Qty (wt. %) | Qty (wt. %) |
| Pre- | Rheosolve T 633 | 3.10 | 3.10 |
| Mix | Water | 17.13 | |

| | | |
|---|---|---|
| CBSX | 0.1-0.2 | 0.1-0.2 |
| DMS-X | 0.5-1.0 | 0.5-1.0 |
| NaOH (50%) | 25-40 | 25-40 |
| Dequest 2066 | 3-7 | 3-7 |
| Acusol 445 | 1-3 | 1-3 |
| Trilon M | 3-7 | 3-7 |
| Lutensol TO8 | 15-20 | 15-20 |
| Water | To 100 | To 100 |

The results of the Brookfield viscosity analysis and degree of separation test are shown in Tables 10 and 11, respectively.

TABLE 10
Stability (% Separation)

| | | Formulation C | | Formuation D | |
|---|---|---|---|---|---|
| Day | | RT | 40° C. | RT | 40° C. |
| 1 | week | | | 0% | 0% |
| 2 | weeks | 0% | 0% | 0% | 0% |
| 3 | weeks | 0% | 0% | 0% | 0% |
| 4 | weeks | | | 0% | 0% |
| 5 | weeks | 0% | 0% | 0% | 0% |
| 6 | weeks | 0% | 0% | 0% | 0% |
| 7 | weeks | 0% | 2.3% | | |

These data show excellent stability using a premix comprising the acrylic thickener. Each of the formulations C-D exhibited minimal separation in temperatures ranging from room temperature to 40° C.

TABLE 11
Viscosity (mPas) (sp. 2, 20 rpm)

| Time | | RT (20° C.) | RT (20° C.) |
|---|---|---|---|
| 1 | day | | 684 |
| 3 | days | 702 | |
| 1 | week | | 750 |
| 2 | weeks | | |
| 3 | weeks | 844 | |
| 4 | weeks | | |
| 5 | weeks | 860 | |
| 6 | weeks | 858 | 610 |
| 7 | weeks | 748 | |

Table 11 shows that Formulations C-D achieve the desired viscosity, as none of the compositions had a viscosity in excess of 1000 mPas. These results show that the compositions of the present application successfully achieve a desirable level of stability while maintaining a preferred viscosity.

### Example 5

A detergent concentrate composition of the application was further evaluated for stability and viscosity. The detergent concentrate compositions were prepared according to Table 12, utilizing an acrylic copolymer as thickener for assessing impact on stability and viscosity of the concentrated detergent composition (emulsion), which was added to a premix of about 14% Rheosolve with about 86% water. Further, the composition of the application was formulated without phosphonate to provide a phosphonate-free composition, and formulated with a lower concentration of alkalinity.

TABLE 12

| Formulation E | Quantity (wt. %) |
|---|---|
| Rheosolve T 633 | 2-4 |
| Optiblanc MTB | 0.1-0.5 |
| DMA-X | 0.5-1.0 |
| NaOH (50%) | 15-30 |
| Na Gluconate | 5-15 |
| Trilon M | 3-7 |
| Acusol 445N | 7-12 |
| Lutensol AO3 | 0.1-2.0 |
| Lutensol AO7 | 5-10 |
| Dehypon LS 54 | 5-10 |
| Water | To 100 |

The composition as shown in Table 12 was compared against a comparative commercially available laundry detergent emulsion composition, Commercial Detergent A, which contains a phosphonate-based chelating agent, and a high molecular weight crosslinked polyacrylic acid polymer for the thickener. The compositions were then evaluated using the procedures described in Example 2 for analyzing both stability and viscosity. The results of the degree of separation test and the Brookfield viscosity analysis are shown in Tables 13 and 14, respectively.

TABLE 13
Stability (% Separation)

| | Separation % after 3 Weeks | |
|---|---|---|
| Composition | 25° C. | 40° C. |
| Formulation E | 0% | 0% |
| Commercial | 0% | 0% |
| Detergent A | | |

These data show excellent stability of Formulation E over the course of 3 weeks. Both Formulation E and Commercial Detergent A demonstrated 0% separation, showing that the compositions are very stable under a wide variety of temperatures. Further, the data show that Formulation E, which is phosphonate-free, is comparable to a phosphonate-based commercial detergent composition containing phosphonate.

TABLE 14
Viscosity (mPas) (sp. 2, 20 rpm)

| | | Formulation E | Commercial Detergent A |
|---|---|---|---|
| Time | | (At 20° C.) | (At 20° C.) |
| 1 | day | 450 | 808 |
| 1 | week | 468 | 620 |
| 4 | weeks | 532 | 594 |

Table 14 shows that both Formulation E and Commercial Detergent A achieved the desired viscosity, as none of the compositions had a viscosity in excess of 1000 mPas. However, as shown in the table, Formulation E was able to achieve much lower viscosity than the commercially available detergent composition. These results show that the compositions of the present application successfully achieve a desirable level of stability while maintaining a preferred viscosity.

### Example 6

The detergency efficacy of a single application of detergent composition was evaluated for the composition of the application in comparison to a comparative commercially available laundry detergent emulsion composition. Artificial stains were manually produced on fabric swatches and added into a centrifugal washing machine with the addition of a full load of soiled or clean laundry (100% polyester). The categories of soils evaluated included (1) fat/pigment soiling, (2) enzymatic stains, and (3) bleachable stains.

Examples of fat pigment soils included lanolin, sebum, olive oil, mineral oil, used motor oil, make-up, and lipstick. Examples of enzymatic stains included blood, milk, cocoa milk, tomato beef sauce, porridge, vegetable oil, and starch. Examples of bleachable stains included tea, red wine, coffee, and black currant juice. The soiled test fabrics were added to the laundry to be washed.

The compositions evaluated were Formulation E and Commercial Detergent A from Example 5. The wash process utilized 0.9 mL/L of the detergent compositions and 0.7 mL/L of a peracetic acid bleach product. The test fabrics were washed for a time period of 12 minutes, at a temperature of about 60° C., and a pH level of about 9.

The test fabrics were evaluated by measuring remission values for the three categories of soils described above through an observation monitor. The remission value represents the amount of light transmission through the fabric swatch after one wash cycle. Therefore, the higher the remission value, the more soil that has been washed off. The average remission percentage value for each of the categories of soils evaluated are shown in Table 15. The goal is to have as high a remission value as possible and for purposes of this study to achieve about the same (or better) performance for the test formulation in comparison to an existing commercial detergent.

TABLE 15

| | Average Remission Percentage | | |
|---|---|---|---|
| | Fat/Pigment | Bleachable | Enzymatic |
| Composition | Soiling | Stains | Stains |
| Formulation E | 45.2 | 86.6 | 59.2 |
| Commercial | 43.6 | 87.8 | 60.6 |
| Detergent A | | | |

As shown in Table 15, Formulation F and Commercial Detergent A demonstrated very similar remission values for all three categories of soils evaluated. Therefore, the results demonstrate that the composition of the present application is comparable in detergency efficacy when compared to a phosphonate-based detergent composition on a variety of types of soils.

### Example 7

A detergent concentrate composition of the application was further evaluated for its fabric brightening properties as compared to a comparative commercially available laundry detergent emulsion composition. The whiteness degrees of various fabrics were measured with a UV light after 25 wash cycles. The fabrics evaluated included 100% cotton, 65% Cotton (CO)/35% Polyester (PES), and 50% cotton/50% polyester. The detergent compositions evaluated included Formulation E and Commercial Detergent A from Example 5. The whiteness evolution was calculated by measuring the reflectance of the swatches before and after the 25 wash cycles were performed. The reflectance values were measured with a Ganz-Griesser whiteness index which is measured in reflectance under UV light. As the measurement is done with UV, the measured whiteness degree is directly influenced by the fluorescence of the optical brightener and hence can be seen as a measure of the efficiency of the detergent and optical brighener. The results of the whiteness degree are shown in Table 16. Further, a ratio of the optical brighteners present in the two compositions are shown in Table 16 as well.

TABLE 16

| | Whiteness Degree with UV | | |
|---|---|---|---|
| | (After 25 wash cycles) | | |
| Composition | Cotton | CO/PES 65/35 | CO/PES 50/50 |
| Formulation E | 209.92 | 208.01 | 209.67 |
| Commercial | 211.8 | 208.9 | 210.2 |
| Detergent A | | | |

Ratio of optical brightener in Commercial Detergent A: Formulation E is 1:0.8

As shown in Table 16, the whiteness degree (with UV) between Formulation E and Commercial Detergent A are comparable. The results demonstrate that the optical brightener mixture utilized in Formulation E (DMS-X and Optiblanc MTB) of the present application is more efficient than the brightener mixture of Commercial Detergent A (Tinopal CBS-X and DMS-X as essentially the same results were achieved with a lower effective concentration based on the 1:0.8 ratio employed. Based on these results, it is expected that if used at the same concentration Formulation E would outperform the existing commercially available detergent. Further, as both compositions contained the DMS-X, it appears the improvement in the whiteness degree is due to the inclusion of the Optiblanc (a triazine derivative of stilbene) and the removal of DMS-X (a disulfonic acid containing stilbene derivative).

The detergent compositions were further evaluated for their fabric whitening properties in the presence of a mixture of heavy metals. The addition of the heavy metals tested the efficacy of a gluconate-based chelating agent in Formulation E versus a phosphonate-based chelating agent in Commercial Detergent A. A mixture of heavy metals comprising iron, copper, and manganese were added to each wash cycle. The results of the whiteness degree are shown in Table 17 after 10 wash cycles. Here, the whiteness degree is a direct measure of the complexation capacity of the detergent compositions, as insufficient complexation would lead to yellowing of the fabrics and decrease of the whiteness degree.

TABLE 17

| | Whiteness Degree with UV | | |
|---|---|---|---|
| | (After 10 wash cycles) | | |
| Composition | Cotton | CO/PES 65/35 | CO/PES 50/50 |
| Formulation E | 173.81 | 198.67 | 203.72 |
| Commercial | 169.77 | 197.97 | 201.55 |
| Detergent A | | | |

As shown in Table 17, the detergent composition of the present application demonstrated comparable or higher whiteness degree values after 10 washes compared to the commercial composition. This demonstrates the efficacy of the gluconate-based chelating agent compared to a phosphonate-based chelating agent in increasing the complexation capacity of the detergent composition.

The applications being thus described, it will be obvious that the same may be varied in many ways. Such variations are not to be regarded as a departure from the spirit and scope of the applications and all such modifications are intended to be included within the scope of the following claims. The above specification provides a description of the manufacture and use of the disclosed compositions and methods. Since many embodiments can be made without departing from the spirit and scope of the application, the application resides in the claims.

What is claimed is:

1. A stable liquid detergent composition comprising:
an alkalinity source, wherein the alkalinity source is in a concentration of between about 1 wt. % and about 90 wt. %;
a chelating/sequestering agent, wherein the chelating/sequestering agent is selected from the group consisting of a polymeric chelating/sequestering agent, an aminocarboxylic acid or salt thereof, gluconic acid or a salt thereof, or a mixture thereof,
an acrylic copolymer thickening agent;
at least one nonionic surfactant; and
at least one whitening agent;
wherein the pH of the composition is between about 9 and about 14; and
wherein the composition comprises a stable emulsion having a water phase and an oil phase.

2. The composition of claim 1, wherein the alkalinity source is an alkali metal hydroxide, and wherein the pH is between about 10 and about 14.

3. The composition of claim 1, wherein the composition comprises from about 1 wt. % to about 70 wt. % of the at least one nonionic surfactant.

4. The composition of claim 1, wherein the chelating/sequestering agent is in a concentration from about 0.1 wt. % to about 10 wt. % and comprises a polymeric chelating agent, an aminocarboxylic acid or salt thereof, and gluconic acid or salt thereof.

5. The composition of claim 4, wherein the polycarboxylic acid is an acrylic acid copolymer.

6. The composition of claim 1, wherein the polymeric chelating/sequestering agent comprises a carboxy-methylated polyethyleneimine compound.

7. The composition of claim 1, wherein the at least one whitening agent comprises a 4,4′-distyryl biphenyl derivative, a derivative of bis(triazinyl)amino-stilbene, a bisacylamino derivative of stilbene, a triazole derivative of stilbene, a triazine derivative of stilbene, an oxadiazole derivative of stilbene, an oxazole derivative of stilbene, a styryl derivative of stilbene, or a mixture thereof.

8. The composition of claim 7, wherein the at least one whitening agent is in a concentration of from about 0.01 wt. % to about 5 wt. %.

9. The composition of claim 8, wherein the at least one whitening agent comprises two whitening agents, and wherein the two whitening agents are selected from the group consisting of 4,4′-distyryl biphenyl derivative, a bis-(triazinylamino)-stilbene disulphonic acid derivative, and a triazine derivative of stilbene.

10. The composition of claim 1, wherein the at least one nonionic surfactant comprises an ethoxylated nonionic surfactant.

11. The composition of claim 1, wherein the composition phosphorus free.

12. The composition of claim 1, wherein the composition further comprises a phosphonate in a concentration of from about 1 wt. % to about 20 wt. %.

13. The composition of claim 1, wherein the liquid detergent composition is provided as a concentrate.

14. The composition of claim 1, wherein the composition exhibits less than 10% phase separation for at least one year.

15. The composition of claim 1, further comprising an additional functional ingredient comprising optical brighteners, soil antiredeposition agents, antifoam agents, low foaming surfactants, defoaming surfactants, pigments and dyes, softening agents, anti-static agents, anti-wrinkling agents, dye transfer inhibition/color protection agents, odor removal/odor capturing agents, soil shielding/soil releasing agents, ultraviolet light protection agents, fragrances, sanitizing agents, disinfecting agents, water repellency agents, insect repellency agents, anti-pilling agents, souring agents, mildew removing agents, allergicide agents, and mixtures thereof.

16. A method of washing textiles comprising:
providing the liquid detergent composition according to claim 1; and
washing the textiles in an institutional or a household washing machine.

17. The method of claim 16, further comprising diluting the liquid detergent composition at a point of use with water.

18. A method of dispensing a liquid detergent composition for washing textiles comprising:
dispensing the liquid detergent composition according to claim 1 into a washing machine;
wherein the composition has a viscosity of less than about 1000 mPas.

19. The method of claim 18, wherein the washing machine is an institutional or a household washing machine.

20. The method of claim 18, further comprising diluting the liquid
detergent composition before the liquid detergent composition is dispensed into the washing machine.
